(19) United States
(12) Patent Application Publication
(10) Pub. No.: US 2026/0179131 A1
(43) Pub. Date: Jun. 25, 2026

(54) METHOD AND SYSTEM FOR GENERATING CONTINUOUS VIDEO FROM AI-PROCESSED IMAGES

(71) Applicant: Zazzle Inc., Menlo Park, CA (US)

(72) Inventors: Matthew DIFONZO, Belmont, CA (US); Leslie Young HARVILL, Olympia, WA (US)

(21) Appl. No.: 19/265,666

(22) Filed: Jul. 10, 2025

Related U.S. Application Data
(62) Division of application No. 18/989,537, filed on Dec. 20, 2024.

(51) Int. Cl. G06Q 30/0601; G06T 5/77; G06T 15/50

(52) U.S. Cl. CPC G06Q 30/0621; G06T 5/77; G06T 15/506

(57) ABSTRACT

A computer-implemented method for generating and refining synthetic video content comprises: receiving a text prompt describing a product and a markup; generating a synthetic image of the product having the markup using a generative artificial intelligence (GAI) system; validating the synthetic image against physical product specifications; mapping the synthetic image onto a 3D surface; applying inpainting techniques to remove the markup; generating an enhanced synthetic image by incorporating lighting and specular effects; generating an interactive asset by mapping the enhanced synthetic image onto the 3D surface of the product; generating using the GAI system a video frame sequence; for each frame, generating a vector data file for the interactive asset; generating a video data file based on each vector data file for each frame, and customization instructions; and transmitting the video data file and the customization instructions to a manufacturing entity for rendering of the interactive asset.

### CROSS REFERENCE TO RELATED APPLICATIONS

This application is a divisional of U.S. patent application Ser. No. 18/989,537, filed Dec. 20, 2024, which is hereby incorporated by reference for all purposes as if fully set forth herein.

### TECHNICAL FILED

The present disclosure relates to artificial intelligence technologies, specifically to systems and methods for generating video sequences from marked-up images using AI-assisted processes.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by their inclusion in this section.

With the growth of digital computation capabilities and enhancements in manufacturing processes, goods manufacturing is transforming into producing goods according to individual customization requests received from customer computers. For instance, manufacturers typically fulfill online orders from customers who use their computer systems to customize depictions of generic goods and place orders for individually customized goods online.

Generally, synthetic views are digital depictions of customized objects on computer-based display devices. In the context of digital customization of products, rendering synthetic views of the products before the products are manufactured is quite beneficial. Rendering synthetic views enables users to visually inspect product features and decorations before placing an order. Synthetic views are often a combination of imagery from digital photography. They may include, for example, digital markups and synthetic renderings derived from, for example, 2D, 2.5D, and 3D geometry of the objects.

A markup image is an image that can be annotated with various tools to add notes, shapes, or other markings. In the context of this disclosure, a markup allows marking up a custom product, such as a mug, photograph, t-shirt, and the like, and applying another image to the marked-up custom product.

Some systems on the market offer users the opportunity to order products with customized attributes. For example, in the case of custom-manufactured framed products such as photos, digital images, artwork, and other frameable products, the systems may offer the users the opportunity to order frames with customized sizes and colors. Such systems often provide functionalities for displaying depictions, i.e., synthetic views, of the customized products to help the users visualize their customized products before ordering them. However, customizing products with numerous parameters can be quite challenging. In fact, in some situations, the selection of customization values may negatively affect the appearance and rendering of the final custom products.

Therefore, there is a need to develop systems and methods that enable the customization of products with numerous attributes and characteristics, thereby overcoming the shortcomings described above.

### SUMMARY

The included claims provide a summary of the presented approach.

### BRIEF DESCRIPTION OF THE DRAWINGS

The patent or application file contains at least one drawing executed in color. The Patent Office will provide copies of this patent or patent application publication with color drawings upon request and payment of the necessary fee.

The manner in which the above-recited features of the present disclosure can be understood in detail, a more particular description of the disclosure, briefly summarized above, may be had by reference to aspects, some of which are illustrated in the appended drawings. It is to be noted, however, that the appended drawings illustrate only typical aspects of this present disclosure and are therefore not to be considered limiting of its scope, for the present disclosure may admit to other equally practical aspects.

FIG. 1A is a block diagram showing an example environment for the AI-based markup generation.

FIG. 1B depicts examples of markups applied to example custom products.

FIG. 1C depicts an example of conforming a markup area to a layout specification.

FIG. 1D depicts an example of finding a markup.

FIG. 1E depicts a segmentation example.

FIG. 1F depicts a markup removal example.

FIG. 1G depicts an example of generating a rectangular grid.

FIG. 1H depicts an example of depth estimation.

FIG. 1I depicts an isolation example.

FIG. 1J depicts a process of generating a dynamic composite image.

FIG. 1K depicts a process of generating a dynamic composite video.

FIG. 1L depicts a process of generating a dynamic composite video.

FIG. 2A is an example of utilizing an AI-based image generation approach.

FIG. 2B is an example of an AI-based image generator.

FIG. 3 is a block diagram showing an example environment for designing and manufacturing products.

FIG. 4A is a flow chart depicting an example process for generating and refining synthetic images of customizable products.

FIG. 4B is a flow chart depicting an example process for generating and validating digital markups on customizable products.

FIG. 4C is a flow chart depicting an example process for generating a quadrilateral grid from an image with an alpha channel.

FIG. 4D is a flow chart depicting an example process for generating video sequences.

FIG. 5 is a block diagram that illustrates a computer system with which the techniques herein may be implemented.

All the drawings, descriptions and claims in this disclosure are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

### DESCRIPTION OF EXAMPLE EMBODIMENTS

The following description outlines numerous specific details to provide a thorough understanding of the present approach. It will be apparent, however, that the present approach may be practiced without these specific details. In other instances, well-known structures and devices are shown in block diagram form to avoid unnecessarily obscuring the present approach.

Embodiments are described herein according to the following outline:
1.0. GENERAL OVERVIEW
   1.1. TECHNICAL PROBLEM—TECHNICAL SOLUTION
   1.2. TECHNICAL EFFECTS
   1.3. APPROACH SUMMARY
2.0. NOVELTY ASPECTS
   2.1. EXAMPLES OF NOVEL ASPECTS
   2.2. MARKUPS NOVEL ASPECTS
   2.3. QUADRILATERAL NOVEL ASPECTS
3.0. EXAMPLE EMBODIMENTS
   3.1. EXAMPLE EMBODIMENTS OF THE PRESENT PROCESS
   3.2. EXAMPLE EMBODIMENTS OF THE PRESENT APPARATUS
4.0. COMPUTATION ENVIRONMENT
5.0. GENERATING PRODUCTS WITH MARKUPS
6.0. CONFORMING MARKUP AREAS TO LAYOUT SPECIFICATIONS
7.0. FINDING A MARKUP
8.0. BACKGROUND SEGMENTATION EXAMPLE
9.0. REMOVING MARKUPS
10.0. GENERATING A GRID
11.0. DEPTH ESTIMATION
12.0. ISOLATING LUMINANCE AND SPECULAR LIGHT
13.0. GENERATING DYNAMIC COMPOSITE IMAGES
14.0. EXAMPLE SYSTEM SPECIFICATION
15.0. GENERATING SYNTHETIC IMAGES USING AI
   15.1. REQUESTS
   15.2. AI-BASED IMAGE GENERATOR
   15.3. SYNTHETIC IMAGES
16.0. GENERATING SYNTHETIC VIDEOS USING AI
   16.1. TECHNICAL PROBLEM AND TECHNICAL SOLUTION
   16.2. SUMMARY OF THE APPROACH
   16.3. LEVERAGING AI-ASSISTED MARKUP PROCESS TO GENERATE VIDEO SEQUENCES FROM STILL IMAGES
   16.4. TECHNICAL EFFECTS
   16.5. REQUESTS AND PROMPTS
   16.6. EXAMPLES OF AI-BASED IMAGE GENERATORS
   16.7. GENERATING SYNTHETIC VIDEOS
      16.7.1. FIRST EXAMPLE
      16.7.2. SECOND EXAMPLE
17.0. QUADRILATERAL INTERPOLATION APPROACH
18.0. EXAMPLE COMPUTER ENVIRONMENTS
19.0. GENERATING AND REFINING SYNTHETIC IMAGES OF CUSTOMIZABLE PRODUCTS
   19.1. OVERVIEW
   19.2. EXAMPLE FLOW CHART FOR GENERATING AND REFINING SYNTHETIC IMAGES OF CUSTOMIZABLE PRODUCTS
20.0. GENERATING AND VALIDATING DIGITAL MARKUPS ON CUSTOMIZABLE PRODUCTS
   20.1. OVERVIEW
   20.2. EXAMPLE FLOW CHART FOR GENERATING AND VALIDATING DIGITAL MARKUPS ON CUSTOMIZABLE PRODUCTS
21.0. GENERATING A QUADRILATERAL GRID FROM AN IMAGE ALPHA CHANNEL
   21.1. OVERVIEW
   21.2. EXAMPLE FLOW CHART FOR GENERATING A QUADRILATERAL GRID FROM AN IMAGE ALPHA CHANNEL
22.0. GENERATING CONTINUOUS VIDEO MOTION SEQUENCES FROM AI-PROCESSED IMAGES
   22.1. EXAMPLE FLOW CHART FOR GENERATING VIDEO SEQUENCES
23.0. EXAMPLE BENEFITS OF THE PRESENT APPROACH
24.0. IMPLEMENTATION MECHANISMS

### 1.0. General Overview

In some implementations, approaches for generating and modifying product markups, as well as recognizing markup on products using generative models, are presented. The approaches have been developed to overcome the shortcomings of traditional methods for generating markups and address the issues caused by the inconvenient and time-consuming printing of markups.

### 1.1. Technical Problem—Technical Solution

In the realm of digital image processing, product customization has become increasingly prevalent. With the advent of advanced computational capabilities, manufacturers can now produce goods tailored to individual customer specifications. This shift towards personalized manufacturing has necessitated the development of systems that can accurately and efficiently render digital depictions of customizable products. These digital depictions are often referred to as synthetic views. They allow users to visualize their customized products before placing an order, ensuring that the final product meets their expectations.

Despite the advancements in digital image processing, current solutions for generating synthetic views of customizable products face several challenges. Many existing systems rely on traditional printing markups on products, which can be inconvenient and time-consuming. These methods often require physical prototypes and extensive photography sessions involving models and specific locations to capture the desired product images. This process not only incurs significant costs but also limits the flexibility and speed of customization. Furthermore, the accuracy of these synthetic views is often compromised, as they may not fully conform to the physical specifications of the final product, leading to discrepancies between the digital depiction and the actual manufactured item.

The disclosed approach addresses these challenges by leveraging generative AI to create and refine synthetic images and videos of customizable products. This method eliminates the need for physical prototypes and extensive photography, significantly reducing the time and cost associated with product customization. The system generates a synthetic image or video that accurately reflects the specified attributes, using a text prompt to describe the product and desired markup. The synthetic image is then validated against physical product specifications to ensure conformity. Advanced techniques, such as quadrilateral grid interpolation and inpainting, are employed to enhance the realism and detail of the image.

The final enhanced synthetic image is integrated into an interactive asset, enabling users to interact with and customize the product before it is manufactured. This innovative approach streamlines the customization process, ensuring that the digital depiction closely matches the final manufactured product.

### 1.2. Technical Effects

By receiving and processing a text prompt that describes a product and a desired markup, the present methods enable precise and user-specific customization of synthetic images and videos, ensuring that the generated images and videos meet the user's expectations and requirements.

Generating a synthetic image of the product with the markup using a generative AI system enables the creation of high-quality, realistic images without the need for physical prototypes, significantly reducing the time and cost associated with product visualization and customization.

Validating the synthetic images and videos against physical product specifications ensures that the generated images and videos conform to real-world manufacturing constraints, preventing discrepancies between the digital representation and the actual product, and enhancing the reliability and accuracy of the customization process.

Mapping the synthetic image onto a 3D surface, using, for example, quadrilateral grid interpolation, enables the accurate and realistic placement of the image on the product's surface, taking into account the product's geometry and contours, which enhances the visual fidelity of the synthetic image.

Applying inpainting techniques to remove the markup from the synthetic image while preserving underlying fabric details ensures that the final synthetic image maintains the texture and appearance of the original product, providing a more authentic and visually appealing result.

Incorporating lighting and specular effects to enhance the realism of the synthetic image adds depth and dimension, making it more lifelike and visually engaging. That can improve user satisfaction and the decision-making process during product customization.

Integrating enhanced synthetic images and videos into an interactive asset for customizable product visualization enables users to interact with and modify the product design in real-time, providing a dynamic and engaging user experience that can lead to higher customer satisfaction and more informed selection decisions.

Providing the interactive asset for user interaction and customization before manufacturing enables users to make final adjustments. It also allows the user to approve the customization before the product is manufactured. That reduces the risk of errors in the final product design and increases the user's satisfaction.

The apparatus for generating and refining synthetic images of customizable products allows the integration of multiple specialized modules, each contributing to the overall functionality and efficiency of the system. The generative AI system is configured to create synthetic images with digital markups based on text and image inputs from a module that prepares the inputs based on key-value pairs within the product description. The product description is based on how a product may be customized and manufactured. This reduces the time and cost associated with traditional product visualization methods.

The validation and correction module ensures that the synthetic images conform to physical product specifications, enhancing the accuracy and reliability of the generated images. This module uses machine learning algorithms to compare synthetic images against a database of physical product specifications, ensuring that the final product meets the required standards.

The 3D mapping and image synthesis module may utilize quadrilateral grid interpolation to accurately map user images onto 3D surfaces. This technique enables the realistic representation of the product's surface, taking into account, for example, the contours and folds of the fabric, thereby enhancing the visual realism of the synthetic images.

The inpainting module is designed to remove digital markups from the synthetic images while preserving underlying fabric details. This ensures that the final image maintains the texture and appearance of the original fabric, providing a more authentic and visually appealing representation of the product.

The interactive asset creation system integrates synthetic images into interactive assets for customizable product visualization and manufacturing. This enables users to interact with and customize product images in real-time, providing a more engaging and user-friendly experience.

The depth estimation and image mapping tools refine the placement and appearance of digital markups on 3D models, ensuring that the markups are accurately represented in the final image. This enhances the overall realism and accuracy of the synthetic images.

The lighting and specular effects module applies lighting and specular effects to synthetic images, further enhancing their realism. By simulating various lighting scenarios, the module ensures that the synthetic images accurately reflect how the product would appear under different lighting conditions.

### 2.0. Novelty Aspects

### 2.1. Examples of Novel Aspects

In some implementations, the novelty of the present approaches lies in their comprehensive and technologically advanced approach to generating and refining synthetic images and videos of customizable products using a combination of generative AI, validation techniques, and interactive visualization.

One of the novel aspects is the use of generative AI for creating synthetic images. The present method utilizes a generative AI system to create synthetic images of products based on text prompts describing the product and the desired markup. The approach enables the rapid and flexible generation of product images without the need for physical prototypes or photography.

Another aspect is validation against physical product specifications. The present method includes validating the synthetic images against physical product specifications to ensure conformity. This step ensures that the generated images accurately represent the physical products and meet manufacturing requirements.

Another novel aspect includes a 3D surface mapping using quadrilateral grid interpolation. The present method involves mapping the synthetic images onto 3D surfaces using quadrilateral grid interpolation. This technique ensures that the images conform to the contours and dimensions of the physical products, providing a realistic and accurate representation.

Other aspects include using inpainting techniques for markup removal. The present method employs inpainting techniques to remove digital markups from synthetic images while preserving the underlying fabric details. This step enhances the realism of the images by ensuring that the removal of markups does not affect the product's visual quality.

Additional aspects include the incorporation of lighting and specular effects. The method incorporates lighting and specular effects to enhance the realism of the synthetic images. This approach ensures the images accurately reflect the physical products lighting conditions and material properties.

Other aspects include integrating markups into interactive assets. The present method integrates the enhanced synthetic images into interactive assets for customizable product visualization. This enables users to interact with and customize product images in real-time, providing a highly engaging and user-friendly experience.

Other aspects include real-time customization and user interaction. The method provides interactive assets for user interaction and customization prior to manufacturing. This feature allows users to modify product features directly within the interactive asset, ensuring that the final product meets their preferences and requirements.

Additional aspects include the use of specific product attributes in text prompts. The method enables the inclusion of specific product attributes, such as color, size, or material, in the text prompts used to generate synthetic images. This ensures that the generated images accurately reflect the desired product characteristics.

Other novel aspects include using different AI models. The method utilizes different AI models to generate synthetic images, providing flexibility and adaptability in image generation.

Other aspects include comparison with the Database of Physical Product Specifications. The method includes comparing the synthetic images with a database of physical product specifications for validation, ensuring that the images conform to established standards and requirements.

Overall, the novelty of the present approach lies in its holistic and technologically advanced approach to generating, validating, and refining synthetic images of customizable products, incorporating generative AI, 3D surface mapping, inpainting techniques, lighting effects, and interactive visualization to provide a highly accurate and user-friendly solution for product customization and visualization.

### 2.2. Markups Novel Aspects

A markup is an image that can be annotated with various tools to add notes, shapes, or other markings, and that can be used to mark up a custom product. For example, a markup may be applied to custom products, such as mugs, photographs, and t-shirts, to overlay another image on the marked-up custom products.

Regarding markups, the novelty lies in its comprehensive approach to monitoring and managing communications within a role-based, collaborative system that utilizes advanced technologies. Key novel aspects include machine learning and natural language processing. The collaboration server and monitoring system use machine learning algorithms and natural language processing (NLP) techniques to generate markups and enhance the accuracy of these markups.

### 2.3. Quadrilateral Novel Aspects

In terms of generating markups, the novelty of the present approach lies in its comprehensive and technologically advanced methods for generating a quadrilateral grid from an image with an alpha channel, specifically designed for digital image processing and customization. Key novel aspects include vectorizing shapes from the alpha channel. The present approach involves receiving an image with an alpha channel depicting a shape mapped onto a 3D surface and vectorizing the shape found in the alpha channel to create a vector path. This step ensures a precise and accurate representation of the shape for further processing.

Additional novel aspects include corner detection and centroid calculation. The present methods involve determining the corners of the vector path by calculating a centroid of the vector path and identifying the farthest points from the centroid to establish corner points. The approach ensures accurate identification of the shape's boundaries and corners.

Other novel aspects include winding order and orientation correction. The present method corrects the winding order and orientation of the vector path to ensure a clockwise order. The step is crucial for maintaining the correct orientation of the shape during grid construction.

Other novel aspects include constructing and resampling a quadrilateral grid: The method constructs a quadrilateral grid by setting sub-paths based on the detected corners and resampling the sub-paths to match a specified number of rows and columns. That ensures a uniform and consistent grid structure for further processing.

Additional aspects include weighted interpolation across the grid. The present method performs weighted interpolation across the grid by calculating interpolants for each grid element based on inverse square distance weighting and adjusting the interpolated values according to the distance from contributing edges. That approach provides a plausible physical representation of the shape on the 3D surface.

Other novel aspects include the output and display of the generated grid. The present method generates a quadrilateral grid and displays the resulting output on a computer display device. That step ensures the final grid is accurately represented and visualized for further use.

Additional features and enhancements are recited in the dependent claims. The dependent claims introduce additional features such as normalizing the vector path to fit within a predefined coordinate system, smoothing the vector path using spline interpolation, verifying the clockwise order by calculating the surface normal, and using cubic weighting functions for enhanced accuracy. Those enhancements further improve the precision and reliability of the method.

Overall, the novelty lies in its detailed and systematic approach to generating a quadrilateral grid from an image with an alpha channel, incorporating advanced techniques for vectorization, corner detection, orientation correction, grid construction, and weighted interpolation, resulting in a highly accurate and reliable method for digital image processing and customization.

### 3.0. Example Embodiments

### 3.1. Example Embodiments of the Present Process

In some embodiments, the system for generating and refining synthetic images and videos of customizable products utilizes a generative AI system that can accept text and image inputs to create highly detailed and accurate synthetic images and videos. This system handles various product attributes, such as color, size, and material specified in the text prompt. The generative AI system can utilize multiple AI models to generate synthetic images and videos, ensuring versatility and adaptability in producing a diverse range of product designs.

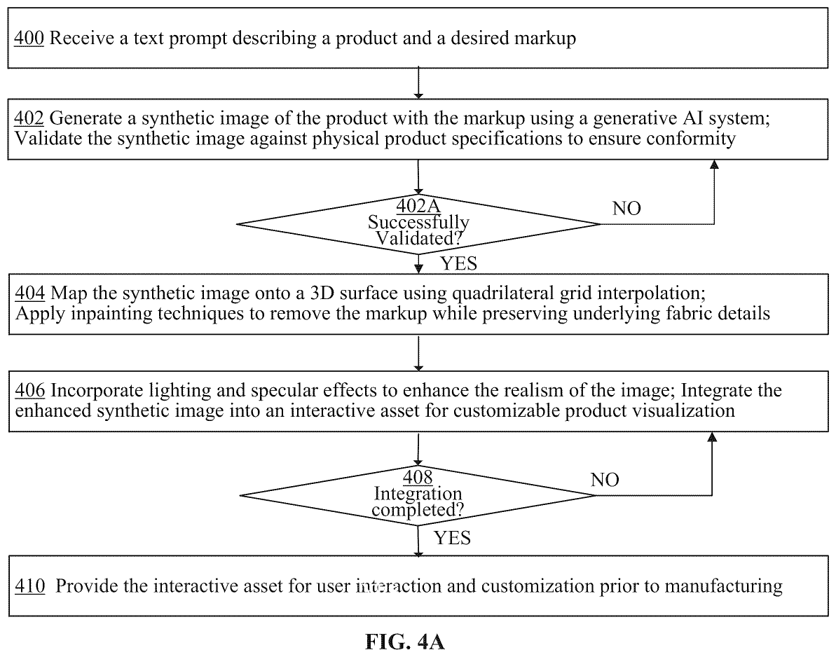

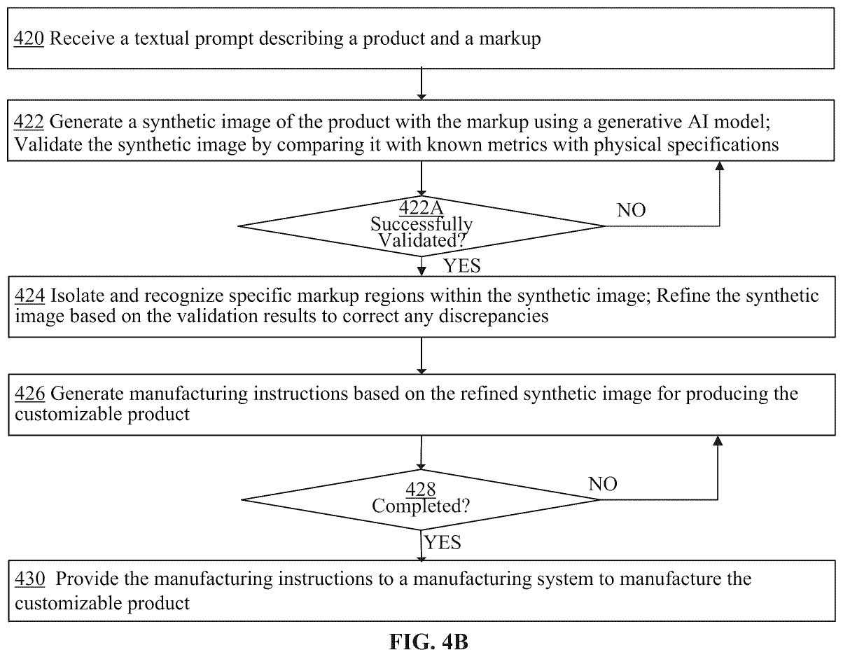

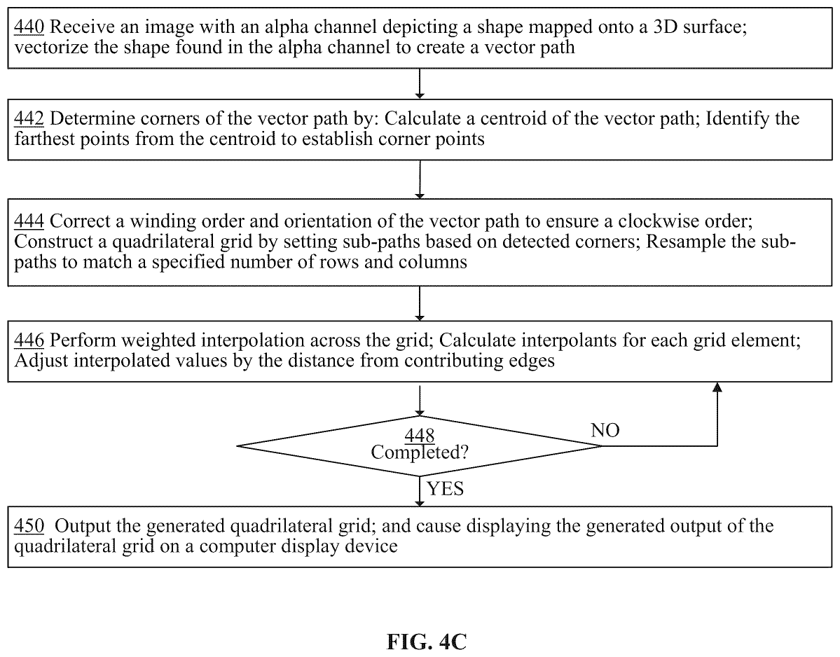

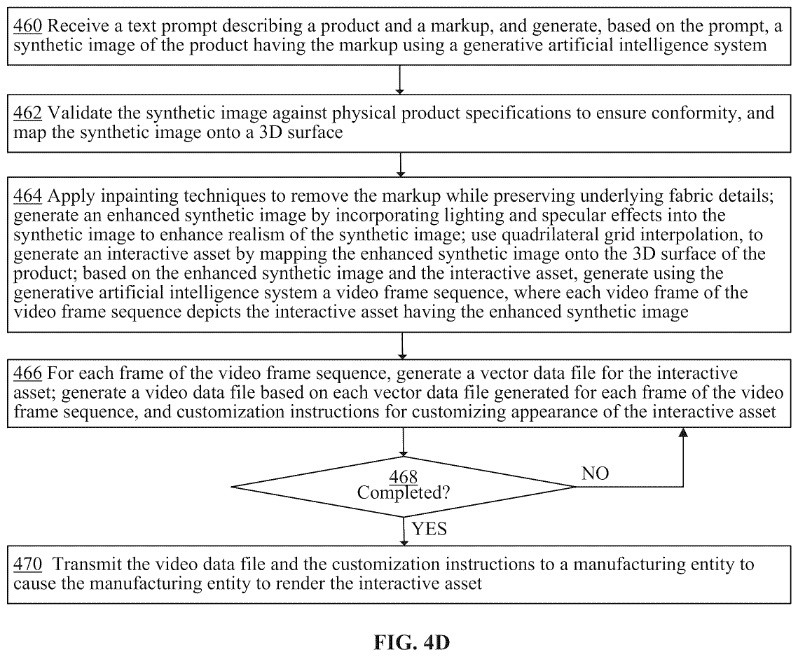

Once the synthetic image is generated, it undergoes a validation process where it is compared against a database of physical product specifications to ensure conformity. The validation step is essential for maintaining the accuracy and reliability of the synthetic images. The method used to validate the physical product may be performed by, but is not limited to, mapping the synthetic image onto a 3D surface using quadrilateral grid interpolation-mapping, then comparing the geometric properties of the mapped grid to properties stored in the database of physical properties. As shown in FIG. 4A, if the physical property constraints are not met, the textual input to the Generative AI may be changed using hints stored in the database of physical properties. Additionally, an input mask may be supplied as input to the Generative AI service. This input mask may be generated by using the quadrilateral grid interpolation map to render the adjusted region based on the correction found in the database of physical properties. The system then maps the synthetic image onto a valid 3D surface using quadrilateral grid interpolation, which can be replaced with alternative interpolation methods, such as spline interpolation, for different surface types. The mapping process ensures that the synthetic image conforms to the physical contours of the product, thereby enhancing its realism and authenticity.

Inpainting techniques can be applied to remove digital markups while preserving the underlying fabric details, utilizing advanced texture synthesis algorithms to maintain the fabric's continuity and integrity. The system also incorporates lighting and specular effects to further enhance the realism of the synthetic image, simulating various lighting scenarios that include both natural and artificial light.

The enhanced synthetic image is then integrated into an interactive asset, allowing users to customize it in real-time. This interactive asset enables users to modify product features directly, providing a highly engaging and personalized experience. The final interactive asset is provided for user interaction and customization before manufacturing, ensuring that the end product meets the user's specifications and expectations.

This embodiment demonstrates the system's adaptability and versatility in generating and refining synthetic images of customizable products, ensuring high accuracy and realism in the final output.

### 3.2. Example Embodiments of the Present Apparatus

In some embodiments, the generative AI system accepts text and image inputs for enhanced customization. It enables users to provide detailed descriptions and visual references, generating synthetic images that closely match their desired product specifications. This embodiment leverages advanced natural language processing and computer vision techniques to interpret and integrate the inputs, ensuring high accuracy and personalization in the generated images and videos.

In some implementations, the generative AI system is designed to generate multiple design variations for user selection, offering a range of options that cater to different aesthetic preferences and functional requirements. The approach utilizes diverse AI models trained on various design styles and product categories, enabling the system to produce a wide array of synthetic images from which users can choose.

Additionally, the validation and correction module in one embodiment incorporates machine learning algorithms that continuously improve accuracy over time by learning from past corrections and user feedback. The adaptive learning capability ensures that the synthetic images remain consistent with physical product specifications, reducing the likelihood of discrepancies and enhancing the system's overall reliability.

In some embodiments, the 3D mapping and image synthesis module employs alternative interpolation methods, such as spline interpolation, to accommodate different surface types and achieve more precise and realistic mappings of synthetic images onto 3D models. This flexibility enables the system to handle a wide range of product shapes and textures, ensuring that the synthetic images accurately reflect the physical characteristics of the products.

Furthermore, the inpainting module offers customizable inpainting parameters, enabling users to define the level of detail preservation according to their specific needs. This feature allows for greater control over the final appearance of synthetic images, ensuring that important product details are preserved while unwanted elements are seamlessly removed.

In some implementations, the present processing techniques also include computational photography approaches and utilize various flow patterns and digital markup patents, field markup patents, and other types of processing.

### 4.0. Computation Environment

All the drawing figures herein and all of the descriptions and claims in this disclosure are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

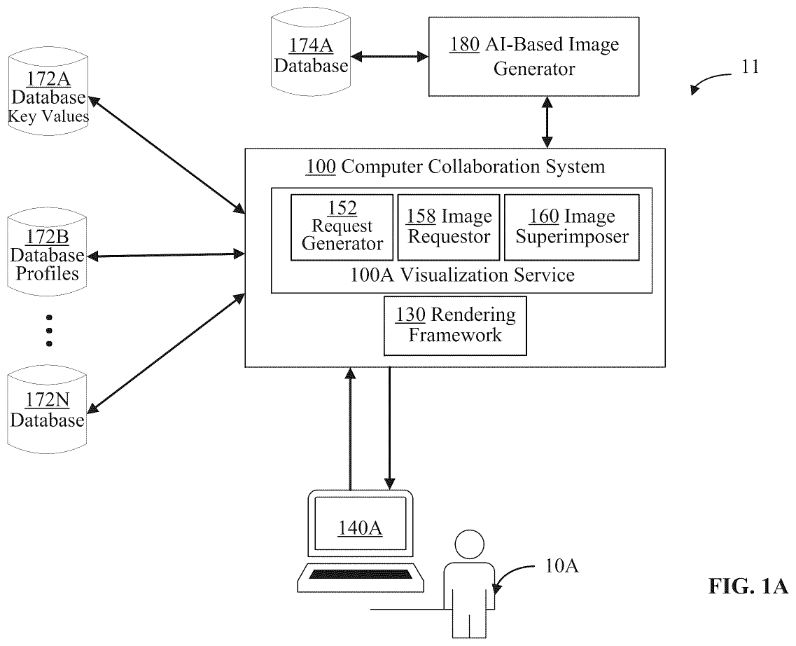

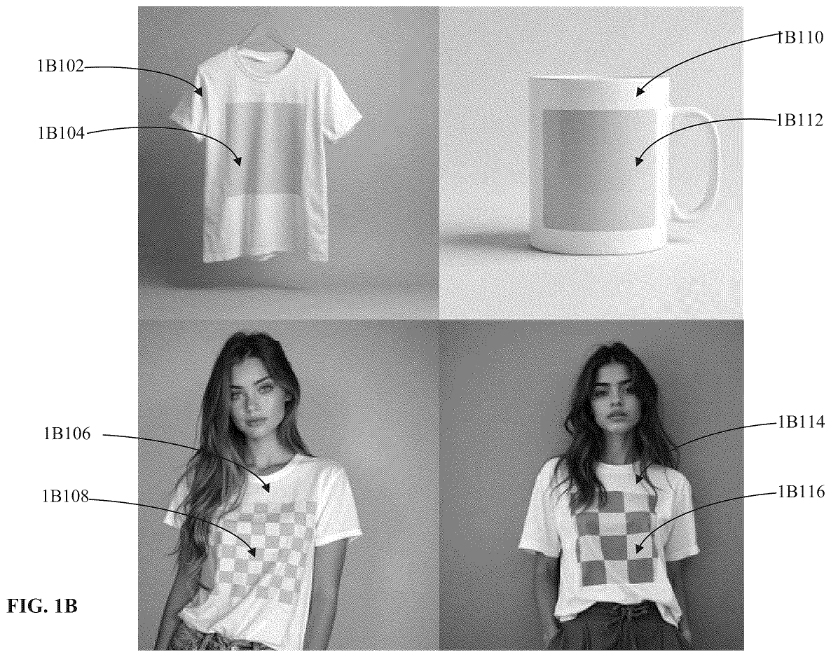

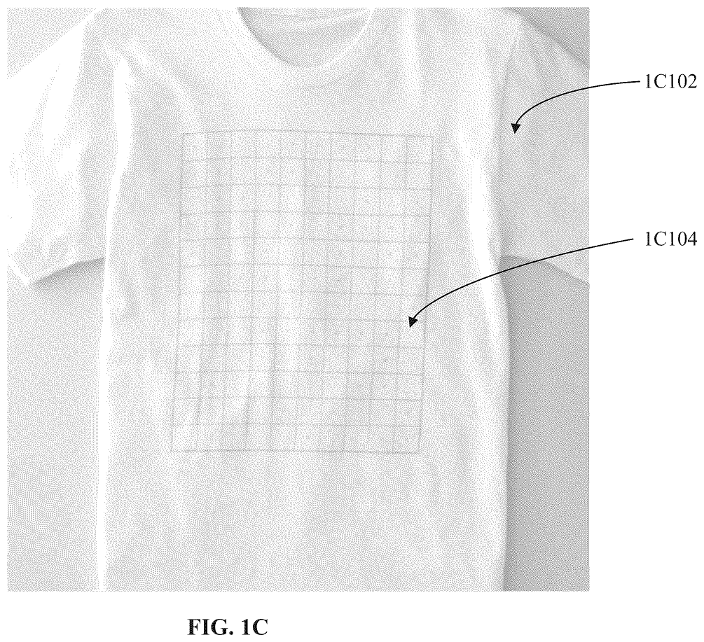

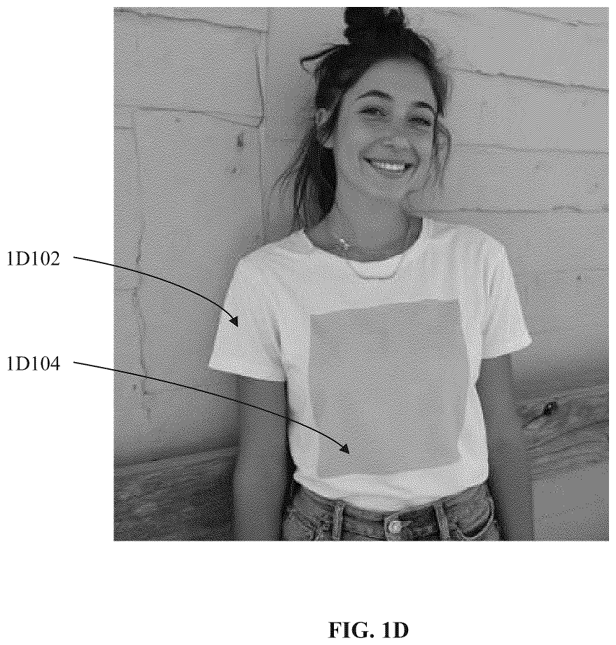

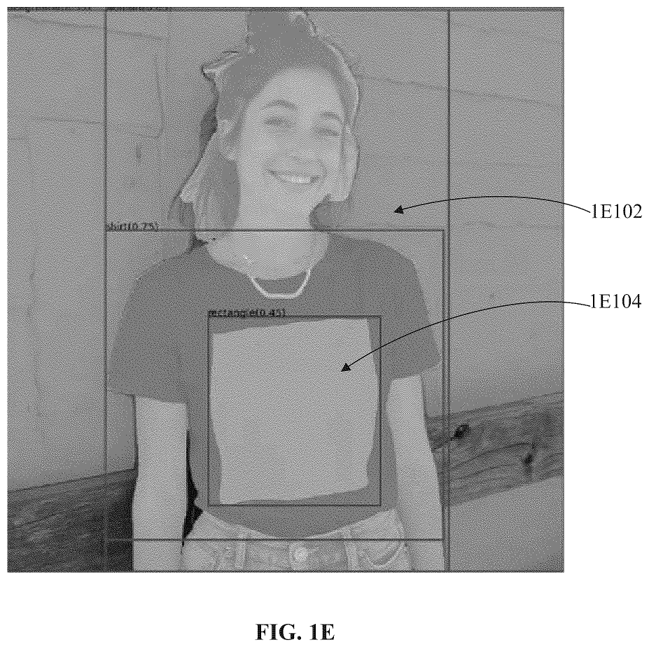

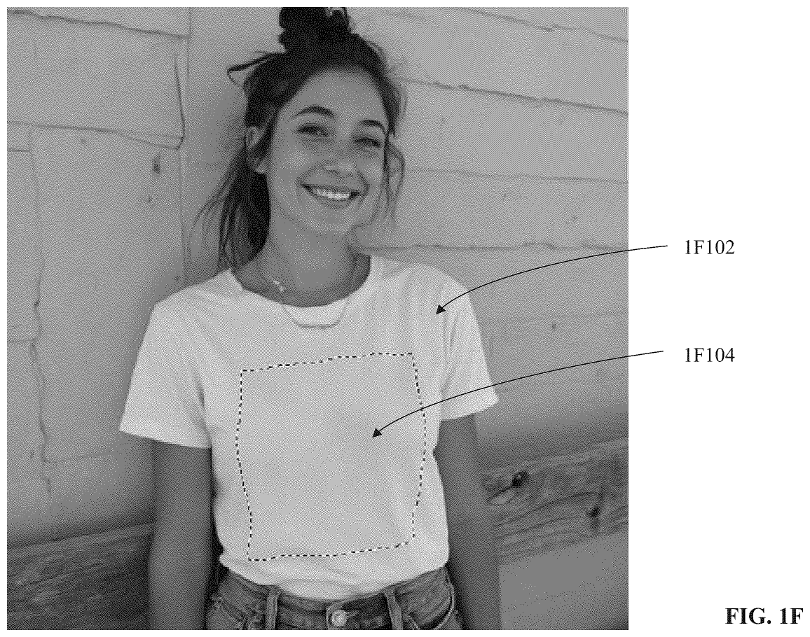

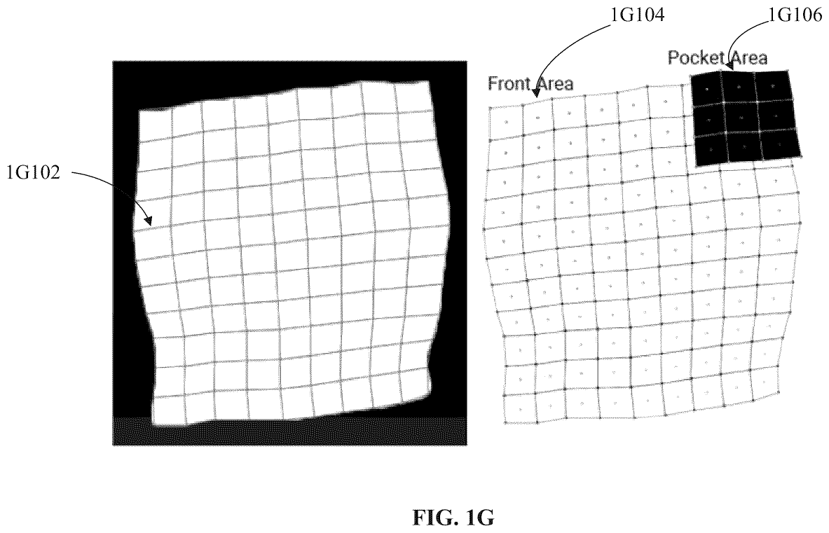

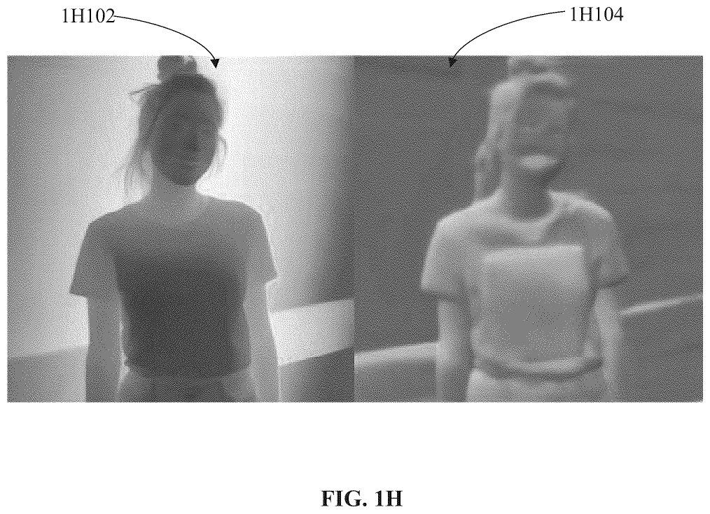

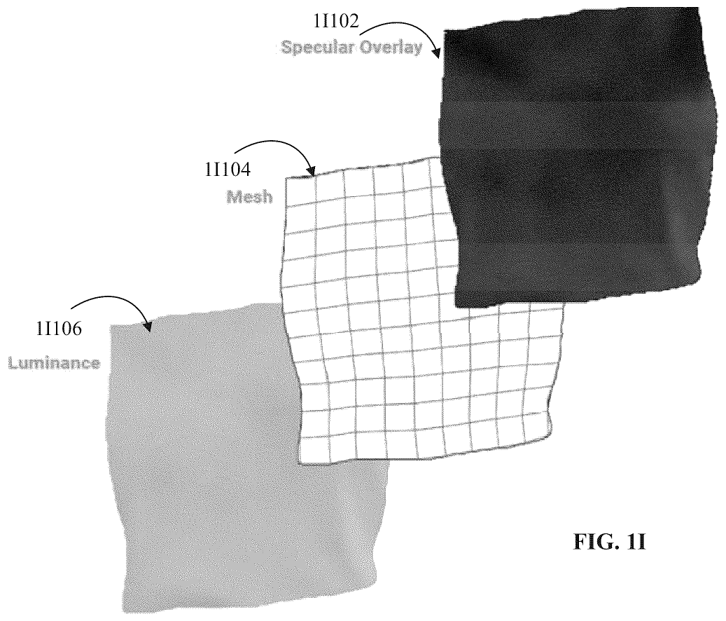

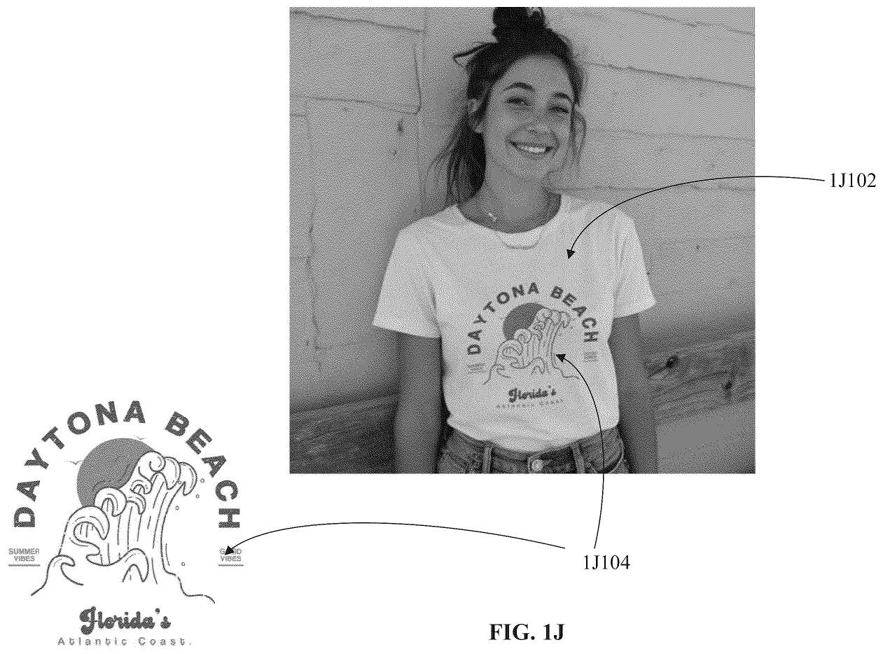

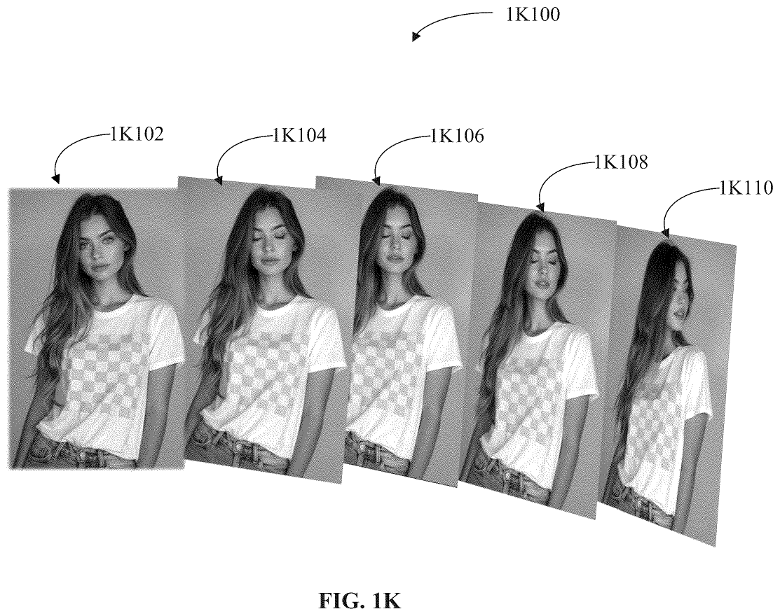

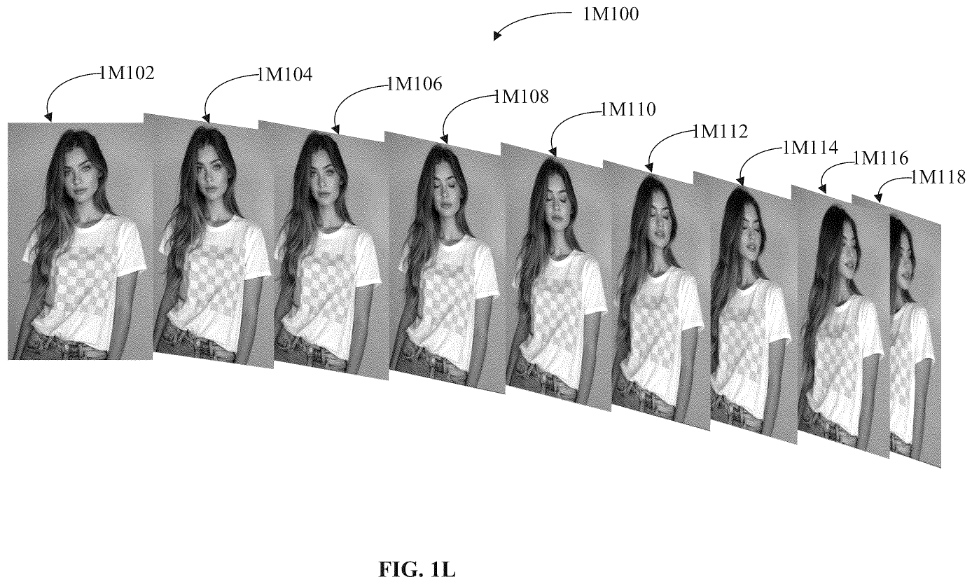

FIG. 1A is a block diagram showing an example environment 11 for the AI-based markup generation. Environment 11 depicted in FIG. 1A is configured to perform contextual resizing and filling in a design area. One of the elements of environment 11 is a computer collaboration system 100.

In some implementations, computer collaboration system 100 comprises a visualization service 100A, comprising a request generator 152, an image requestor 158, an image superimposer 160, and a rendering framework 130 (described in detail later). All components are described in detail later. Image requestor 158 may receive requests to generate a markup. Image superimposer 160 may be configured to superimpose a markup onto a customized product, as described later.

Collaboration system 100 may also include other components, examples of which are described later.

In some implementations, environment 11 also includes a database 172A storing key-value pairs (described later), a database 172B storing user profiles (described later), and one or more other databases 172N for storing additional information used by various components of environment 11 and/or computer collaboration system 100.

Environment 11 may also include a database 174A or a distributed or cloud-based system that can be used as storage for, e.g., billions of digital images, such as publicly available images. Such images may be downloaded from public resources, databases, and other repositories. For example, the images may be downloaded from the Internet and represent part of the DALL-E system (described later).

Images stored in database 174A or some other storage included in environment 11 may be used by an AI-based image generator 180. AI-based image generator 180 may be an AI-based application configured to, for example, implement the stable diffusion approach for generating markup images or synthesizing images in response to a textual query.

### 5.0. Generating Products with Markups

According to the present approach, customized products and markups may be generated using various generative AI approaches, such as Stable Diffusion. Other Gen-AI-based approaches may also be used.

FIG. 1B depicts examples of markups applied to example custom products. The depicted examples include a shirt 1B102 with a markup 1B104, a shirt 1B106 with a markup 1B108, a mug 1B110 with a markup 1B112, and a shirt 1B114 with a markup 1B116. Markup 1B104 is a yellow rectangle. Markup 1B108 is a yellow checkerboard. Markup 1B112 is a yellow rectangle. Markup 1B116 is a yellow and magenta checkerboard. While the depicted markups are rectangular, other shapes of markups can also be used. Furthermore, additional colors may also be used.

The images with the markups may be generated by issuing a prompt as input to a GenAI application. An example prompt may include “a studio-quality photograph of a woman wearing a white t-shirt with a large yellow and magenta checkerboard printed on it.” Another prompt example may include “a studio quality photograph of an 11 oz white mug with a large yellow rectangle printed on it.”

### 6.0. Conforming Markup Areas to Layout Specifications

In some embodiments, a combined generated product and markup area is validated against a physical printed sample to ensure that it accurately reflects the dimensions defined in the layout specified for the product. The validation ensures that the generated product and markup accurately represent the physical product according to the specification.

FIG. 1C depicts an example of conforming a markup area to a layout specification. The illustrated example shows that a markup 1C104 is applied to a t-shirt 1C102. The application of markup 1C104 to t-shirt 1C102 is then validated to ensure that the resulting product with the markup accurately represents a physical product according to the provided specification.

### 7.0. Finding a Markup

Once the location of a markup image applied to a custom product conforms to a provided specification, the location of the markup is determined, and the markup is separated from the custom product. An example process to separate the markup from the custom product may include various techniques, such as color or instance segmentation, using Mask R-CNN.

FIG. 1D depicts an example of finding a markup. In the illustrated example, a markup 1D104 is applied to a custom t-shirt 1D102. Once it is determined that markup 1D104 is applied to custom t-shirt 1D102 according to the provided specification, markup 1D104 is separated from custom t-shirt 1D102. For example, the separation may be performed by segmenting markup 1D102 using color segmentation, including separating the yellow pixels of markup 1D102 from other pixels, including the white pixels of custom t-shirt 1D104.

### 8.0. Background Segmentation Example

In addition to segmenting or separating markup from a custom product in a picture, the segmentation process may also be applied to isolate the custom product from a background depicted in the image.

FIG. 1E depicts a segmentation example. In this example, the image is segmented into two parts: a custom product with a markup 1E104 from a background 1E102.

### 9.0. Removing Markups

An example process for removing a markup typically begins with determining a mask that covers the markup. The mask of the markup region is generally included in the markup selection. A technique such as inpainting or generative fill may be used to remove the markup while preserving the product's contour. This may become the base layer on which other layers are composited.

FIG. 1F depicts a markup removal example. In the example, the markup in a custom t-shirt (1F102) has been removed. The corresponding markup region is shown as a markup layer 1F104.

### 10.0. Generating a Grid

In the next step, a rectangular grid is generated based on a markup region obtained by removing the markup from a depiction of the custom product. In some implementations, a function (mFlowInterpQuadFromAlpha) is used to conform a rectangular grid to the space defined by the outer extents of the markup region. The mesh can then be used as a target to conform input images and subdivided to accommodate multiple areas, such as the pocket area for a t-shirt.

FIG. 1G depicts an example of generating a rectangular grid. In the depicted example, the markup region has been converted to a rectangular grid 1G102. In this particular example, grid 1G102, which has a front area 1G104, is subdivided into various areas, including a packet area 1G106. In some embodiments, grid 1G102 is represented as a 2D grid, while in others, grid 1G102 is represented as a 3D grid.

### 11.0. Depth Estimation

FIG. 1H depicts an example of depth estimation. The illustrated example shows two images: a left image, 1H102, and a right image, 1H104. Left image 1H102 is an image in which a depth map was calculated using MiDaS, Marigold, or similar depth estimation from a single input image. This depth map is used to assist with image segmentation and to conform the mesh to the product's contour.

The right image 1H104 is a normal map that can be used in conjunction with the depth map, where certain features require more isolation.

### 12.0. Isolating Luminance and Specular Light

In the next step, luminance and specular light are isolated in the grid image. FIG. 1I depicts an isolation example. The depicted example illustrates the results of executing an isolation process on a markup region mask to isolate the corresponding custom product's luminance and generate specular overlay lighting effects to blend on top of a middle mesh layer.

More specifically, FIG. 1I shows a specular overlay 11102, a mesh 11104, and a luminance map 11106.

### 13.0. Generating Dynamic Composite Images

The next step combines a base image and the corresponding layers into a resulting image. The resulting image comprises a mesh layer as input via a key-value pair, facilitating the insertion of design images that conform to a 3D space defined by the mesh.

It should be noted that the application of a design image to a custom product is performed in a way that ensures the applied design image follows the curvature of the custom product's surface, including wrinkles, depressions, and other features.

FIG. 1J depicts a process of generating a dynamic composite image. In the depicted example, a design image 1J104 is applied to the rectangular grid, which is determined and isolated in a t-shirt 1J102. The determination and isolation of the rectangular grid were described above.

The depicted example illustrates a straightforward application of a design to a custom product. In other examples, the applications may be more complex. For example, they may include the application of several design images to various areas of the custom object.

### 14.0. Example System Specification

An example system specification described herein includes definitions of system characteristics and parameters. One of them provides custom product description key-value pairs. As described later, the key-value pairs define various characteristics and elements of a custom product, as well as the customization process. For example, some key-value pairs (described later) may define layout elements, such as product attributes (e.g., a size defined using a manufacturer's size notation, a physical measurement for a lay-down, physical measurements in use, and the like).

The layout elements may also define customized areas, such as process types and the like. The process types may include, for example, a color profile, optical characteristics (e.g., layering, diffuse and specular reflectance, etc.), and the like.

The layer elements may also include size definitions, physical measurements, and visible area definitions (for manufacturing, lay-down, and in-use, such as a proportion of a visible product to the visible area). The size definition may also include definitions of bleed areas and the like.

The customized area parameters may also include definitions of product placements, such as physical measurements obtained from product landmarks and similar features.

In addition to the layout elements, the key-value pairs may include descriptive phrases, such as typical environments for, for example, marketing uses, typical users for marketing uses, blocking descriptors, lighting descriptors, product descriptive phrases, and markup descriptive phrases.

Examples of typical environments for marketing uses may include definitions of places, activities, and the like. An example prompt for “Urban Rooftop Vibes” may capture the essence of city living by showcasing models against the backdrop of a sunlit rooftop with towering skyscrapers and expansive skyline views in the distance, creating a blend of street style and high-fashion energy.

Descriptive phrases may also include definitions of typical users for marketing purposes. This may include socio-cultural descriptors, cosmetic descriptors, age-gender descriptors, and similar characteristics. An example prompt for “Athletic and empowered may include a strong, fit model with a toned physique and dynamic movements, embodying an active lifestyle. Whether mid-action or in still poses, their presence conveys determination, strength, and vitality.”

Descriptive phrases may also include definitions of blocking descriptors. Example prompts may include “over-the-shoulder-gaze,” and “block the model with their back to the camera, subtly turning their head for an over-the-shoulder look.”

Descriptive phrases may further include definitions of lighting descriptors, such as a light direction, a light type (e.g., sunlight (morning, daylight, evening, seasonal), artificial (e.g., stage, portrait, location), light geometry (e.g., point sources, spot, fill light), and the like. An example prompt for “high-key lighting” may include “create a bright, airy atmosphere with minimal shadows, where the subject is illuminated with evenly distributed soft light, set against a predominantly white or light-color background.”

Descriptive phrases may also include product-specific phrases, such as defining phrases, sizing phrases, and attribute phrases (e.g., color, surface), among others. Those descriptors can be specified as a purely generative prompt or pulled directly from the keys and values of the products themselves. Some examples from product data may include “an 11 oz white ceramic mug” or “a woman's white crew neck tri-blend t-shirt.”

Descriptive phrases may also include markup. Example prompts may include “a yellow rectangle printed on the front of the product” and “a yellow and magenta checkerboard printed on the front of the product.”

An example system specification described herein may also include definitions of custom product imagery. They may include definitions of previous images with markup of known products. They may include metrics from digital assets, such as the view orientation of the product, placement of design areas, coverage of design areas, the ratio of visible product to design area, and the like.

An example system specification described herein may also include definitions of generative image creation. This may include inputs for generative creation, such as textual input (using descriptive phrases from product descriptions or generating descriptive phrases to create markup) and image input (using custom product imagery or examples of custom product imagery to generate markup).

An example system specification described herein may also include definitions of markup processing, such as segmentation, layout detection (including quadrilateral grid interpolation and quadrilateral grid fitting), and image synthesis.

An example system specification described herein may also include definitions of generative image evaluation, including comparisons of markup metrics from a generated image with metrics from custom product imagery (including a comparison placement, a comparison coverage ratio, and a lighting comparison).

An example system specification described herein may also include definitions of generative image correction, including definitions of adjustment of markup (such as adjustment by resampling quadrilateral grid, extensions of markup by extrapolation of the quadrilateral grid, and repositioning by resampling of the quadrilateral grid), and adjustment by modification of descriptive phrases to generate markups (including use phrases dictionary for size adjustment, and use phrases dictionary for placement adjustment).

An example system specification described herein may also include definitions of generative image embedding in interactive custom product assets, including generative images with markups that are processed similarly to photographic imagery with markups.

An example system specification described herein may also include definitions of manufacturing interactive custom product assets based on a user's choice of customizable key-value pairs in the product description.

An example system specification described herein may also include definitions for correcting custom product descriptive phrases, including comparisons of generative images with physical products and adjustments to custom product descriptive phrases.

### 15.0. Generating Synthetic Images Using AI

### 15.1. Requests

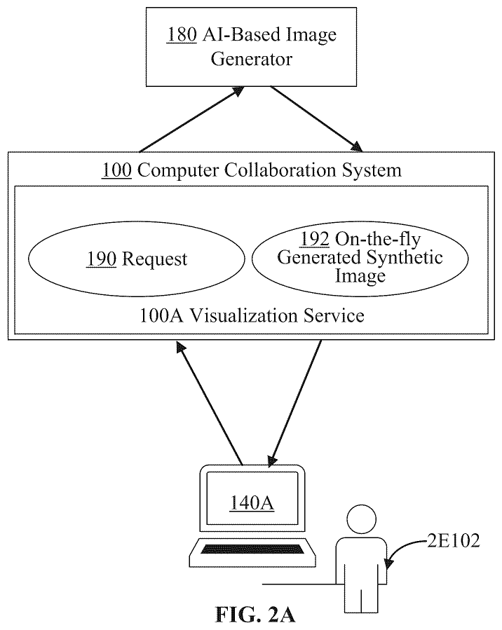

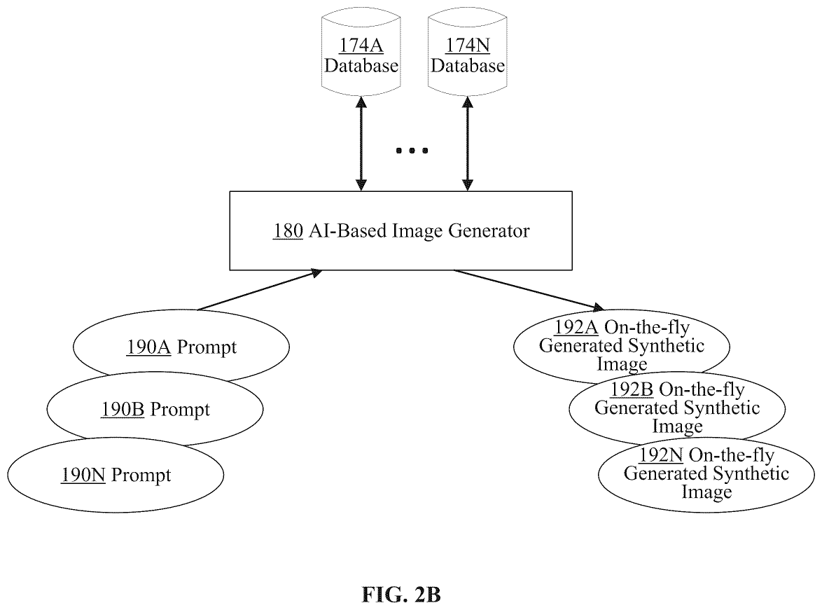

FIG. 2A is an example of utilizing an AI-based image generation approach. In the depicted example, synthetic images and videos may be generated as a result of collaboration between the computer collaboration system 100, the AI-based image generator 180, and a user 2E102 operating a user computer 140A.

In some embodiments, computer collaboration system 100 uses its visualization service 100A to communicate with AI-based image generator 180.

User computer 140A may receive customization requests from user 2E102, selections of custom products, and other requests to the computer collaboration system 100. User computer 140A may also be used to display a graphical visualization of custom products, including the visualization of on-the-fly generated AI-based images that have been merged with or incorporated into the visualization of the custom products.

Computer collaboration system 100 (or its visualization service 100A) may receive a graphical representation of a custom digital product, such as a mug product, a t-shirt, and the like. The graphical representation of a product may include encoded information about the product and its description, including the key-value pairs described later.

In some embodiments, a graphical representation of the custom digital product comprises product description data for a custom digital product. The product description data comprises a plurality of parameters for the custom digital product, and each parameter is represented as a key-value pair. A key-value pair is a data structure that includes an attribute key and a corresponding attribute value.

Based on the received product description and the user's profile, events, and other relevant information, the visualization service 100A determines one or more regions within the depiction of the custom product. The regions may be customized when displaying the graphical representation of the custom digital product on a display device.

A region may be a markup region described above. It may be determined based on the information included in the graphical representation of the product, the key-value pairs, a user's profile, and the like. The regions may include the background to be shown behind a depiction of the product or other regions to be displayed behind a depiction (or depictions) of the product or within the depiction of the product.

For each region, visualization service 100A determines a set of keywords/phrases specific to the custom digital product and the customization of the custom digital product. The phrases may include one or more key-value pairs extracted from the product description data. The phrases may also include one or more pieces of information extracted from a user's profile, which the user has customized to create the custom digital product. The set of phrases may further include one or more pieces of information extracted from a repository of events associated with the custom digital product.

For each region, the corresponding keywords/phrases may be used to create a prompt corresponding to request 190.

A prompt may be a textual request that pertains to a request for synthetic image generation. It is possible to generate multiple requests for a single region.

All the requests may be transmitted by visualization service 100A to an AI-based image generator.

### 15.2. AI-Based Image Generator

AI-based image generator 180 is configured to receive requests for synthetic images, generate synthetic images in response to receiving the requests, and provide the generated synthetic images to visualization service 200A.

FIG. 2B is an example of an AI-based image generator. An AI-based image generator 180 may receive a plurality of prompts 190A, 190B . . . 190N. The prompts may pertain to a markup region within a customization image.

AI-based image generator 180 may be configured to access one or more databases, such as database 174A-174N. A database may store image repositories, training data, training models, learning models, and other related data.

In response to receiving prompts 190A-190N, AI-based image generator 180 may generate one or more on-the-fly generated synthetic images 190A-190N.

### 15.3. Synthetic Images

Synthetic images can be generated based on the keywords or phrases included in the corresponding prompts. For each prompt, one or more synthetic images may be generated. As described before, each on-the-fly synthetic image is synthesized and generated from one or more images retrieved from database(s) 174A-174N. Therefore, none of the synthetic images 190A-190N looks like any of those stored in the repository.

For each prompt 190, upon receiving the request, AI-based image generator 180 generates a customized synthetic image, at least in part, based on the prompt and a repository of images, as described earlier. The customized synthetic image is not a copy of any image from the image repository. Instead, the customized synthetic image is generated by synthesizing a set of images that an AI-based image generator selects from the repository of images and then synthesizes the selected images.

Referring again to FIG. 2A, once the customized synthetic images are generated by AI-based image generator 180, the generator transmits the images to the computer collaboration system 100, and the virtualization service stores the images as on-the-fly generated synthetic images 192.

Upon receiving on-the-fly generated synthetic images 192, visualization service 100A matches the received images with the corresponding regions, includes the images in the corresponding areas, and generates a graphical visualization of the custom product and the corresponding synthetic images.

Then, visualization service 100A displays, on the display device, the graphical visualization of the custom digital product along with the customized synthetic images in the corresponding regions.

The graphical visualization and the graphical representation of the custom digital product may be transmitted or otherwise provided to a manufacturing product rendering unit of a manufacturing entity. The manufacturing product rendering unit may render the graphical visualization and representation of the custom digital product, and, for example, print it using printing instructions generated by the manufacturing product rendering unit, thereby producing a physical representation of the custom digital product.

### 16.0. Generating Synthetic Videos Using AI

### 16.1. Technical Problem and Technical Solution

The customization and visualization of products, particularly in the context of digital design, have traditionally relied on static images or rudimentary 3D models, rather than videos. While these approaches provide a basic representation of a product, they often fail to capture the dynamic and interactive nature of real-world product customization.

Existing methods for generating product visuals are typically labor-intensive, requiring manual design adjustments or relying on pre-rendered assets that lack flexibility.

Furthermore, the integration of user-specific customizations, such as logos or text, into product visuals often yields unrealistic or poorly aligned outputs, particularly when attempting to simulate complex surfaces, lighting conditions, or material textures. These limitations hinder the ability of manufacturers, designers, and consumers to visualize and interact with customized products realistically and accurately.

The present disclosure addresses these shortcomings by introducing a novel system and method for generating and refining synthetic video content of customizable products using generative artificial intelligence. Unlike conventional approaches, the described system leverages advanced AI models to dynamically generate synthetic images and video sequences based on user-provided text prompts and customization inputs. By incorporating specialized algorithms, such as quadrilateral grid interpolation for 3D surface mapping and inpainting techniques for preserving fabric or material details, the system ensures that the generated visuals are both realistic and adaptable.

Additionally, the described approach integrates lighting and specular effects to enhance the realism of synthetic images, while validation modules ensure conformity with physical product specifications.

Furthermore, the described solution extends beyond static imagery by enabling the generation of interactive video sequences. Starting from a single synthetic image, the system employs generative AI to produce a sequence of video frames that depict the customized product in motion. This process is enhanced by the use of vector data files for each frame, allowing for precise geometry and customization instructions to be embedded into the video content. The resulting video data file can be transmitted to manufacturing entities or client systems, enabling seamless rendering and real-time customization of the product visualization. By combining advanced AI techniques with robust system architecture, the described approach provides a transformative method for product customization, offering new levels of realism, interactivity, and efficiency.

### 16.2. Summary of the Approach

One aspect of the described system lies in its ability to seamlessly integrate generative artificial intelligence systems for creating synthetic video content of customizable products, leveraging advanced techniques such as quadrilateral grid interpolation, inpainting, and lighting enhancement to ensure realism and conformity with physical product specifications.

Unlike traditional methods that generate static images or require frame-by-frame video creation, the described system introduces a streamlined process where a single input image or text prompt can be transformed into a dynamic video frame sequence depicting interactive assets.

The system further incorporates validation mechanisms, vector data generation, and customization instructions, enabling real-time product visualization and manufacturing. Additionally, the apparatus and non-transitory computer-readable storage medium provide modular components, such as depth estimation tools and texture synthesis algorithms, to refine the synthetic content, ensuring adaptability across various AI models and design software.

This comprehensive approach not only enhances the realism and interactivity of synthetic video content but also establishes a scalable framework for AI-driven product customization and visualization.

### 16.3. Leveraging AI-Assisted Markup Process to Generate Video Sequences from Still Images

In some implementations, the approach focuses on leveraging AI-assisted markup processes to generate video sequences from still images. Below is a breakdown of the described technology into potential patent-worthy ideas, assessed against the criteria of novelty, inventiveness, utility, and subject matter eligibility.

For example, the described technology introduces the concept of using AI-assisted markup processes, initially designed for still images, to generate video sequences. This involves feeding a single marked-up image into an AI model to produce a multi-frame video sequence. The application of this process to video generation is novel, particularly in the context of leveraging the same markup definitions and processes for motion interpolation. The idea of extending AI-assisted markup to video generation demonstrates a level of creativity, as adapting the static image markup process involves addressing motion dynamics and maintaining frame continuity. The described technology has practical applications in video production, animation, and product visualization, making it useful.

Furthermore, the described technology emphasizes a model-agnostic approach to video generation, where the AI-assisted markup process can be applied regardless of the specific image-to-video model used (e.g., 12.1, LTX, Video). The model-agnostic approach ensures flexibility and adaptability, which is often overlooked in existing video generation systems. The ability to integrate various open-source image-to-video models without dependency on a specific model demonstrates an inventive step. This approach enables broader applicability and scalability, making the method suitable for a diverse range of applications.

Moreover, the described technology enables the generation of an entire video sequence from a single input image using AI models. This approach removes the requirement for frame-by-frame generation. Generating a multi-frame video from a single image is a novel approach compared to traditional methods, which require the generation of individual frames. The use of AI to interpolate motion and generate coherent video sequences from a single image demonstrates a level of creativity and innovation that is not readily apparent.

### 16.4. Technical Effects

A computer-implemented method described herein enables the generation and refinement of synthetic video content for customizable products. The method involves multiple steps, including receiving a text prompt, generating synthetic images using generative AI, validating the images against physical specifications, mapping the images onto 3D surfaces, applying inpainting techniques, enhancing realism through lighting effects, generating video frame sequences, creating vector data files, and transmitting video data files for manufacturing purposes. Below are examples of the technical impacts associated with this claim:

Efficient Generation of Synthetic Images and Videos: By utilizing generative artificial intelligence systems, the method enables the automated creation of synthetic images and video content based on text prompts. This eliminates the need for manual design processes, significantly reducing the time and effort required to produce high-quality visual assets for customizable products.

Improved Accuracy and Conformity to Physical Specifications: The validation step ensures that the synthetic images conform to physical product specifications, reducing discrepancies between digital representations and real-world products. This enhances the reliability of the generated assets for manufacturing and visualization purposes.

Enhanced Realism in Visual Representations: The incorporation of lighting and specular effects into the synthetic images improves the visual realism of the generated content. This makes the synthetic images and videos more suitable for applications such as marketing, product visualization, and customer engagement.

Seamless Integration with 3D Models: The use of quadrilateral grid interpolation for mapping synthetic images onto 3D surfaces ensures accurate alignment and placement of the images on the product models. This facilitates the creation of interactive assets that can be used for real-time customization and visualization.

Preservation of Product Details during Customization: The application of inpainting techniques to remove markups while preserving underlying fabric details ensures that the integrity of the product's visual characteristics is maintained. This is particularly important for products with intricate textures or patterns.

Automated Video Frame Sequence Generation: The method leverages generative AI to produce video frame sequences from enhanced synthetic images and interactive assets. This automation streamlines the process of creating dynamic visual content, enabling the generation of videos that depict customizable products in motion.

Facilitation of Manufacturing Processes: By generating vector data files and video data files for each frame of the video sequence, the method provides detailed instructions for manufacturing entities. This ensures that the interactive assets can be accurately rendered and customized during production.

Support for Real-Time Customization: The interactive asset generated by the method enables real-time customization of the synthetic images, allowing users to modify product attributes dynamically. This enhances user engagement and provides a more personalized experience.

Scalability and Versatility: The method supports the generation of synthetic images and videos for a wide range of products and customization options. This adaptability allows application across various industries, including fashion, automotive, and consumer goods.

Reduction in Computational Overhead: By generating vector data files for each frame and using them to create video data files, the method optimizes the storage and transmission of video content. This reduces computational overhead and improves the efficiency of data handling.

Streamlined Communication with Manufacturing Entities: The transmission of video data files and customization instructions to manufacturing entities ensures a direct and efficient workflow from design to production. This minimizes errors and accelerates the manufacturing process.

These technical effects collectively highlight the advantages of the claimed method in terms of efficiency, accuracy, realism, and practical applicability in generating and refining synthetic video content for customizable products

### 16.5. Requests and Prompts

Below are non-limiting examples of text prompts that could be used with the described system to generate synthetic images and video content of customizable products:

For individual images, examples of prompts may include:
a. “A studio quality photograph of a woman wearing a white t-shirt with a large yellow and magenta checkerboard printed on it.”

For the video, using the aforementioned generated image as input:
a. “A professional model is taking part in a photo shoot. She is smiling and moving slightly, sometimes turning from side to side.”

Generally, for Apparel Customization:
“Generate a synthetic image of a red t-shirt with a ‘Happy Holidays’ logo in white text on the front.”
“Create a video of a blue denim jacket with a custom embroidered patch of a sunflower on the back, rotating under natural lighting.”
“Show a black hoodie with a glowing neon green dragon design on the chest, displayed in a 360-degree video.”

Generally, for Footwear Customization:
“Generate a synthetic image of white sneakers with a custom rainbow gradient on the sides.”
“Create a video of a pair of leather boots with a custom monogram ‘J.D.’ embossed on the ankle, displayed under studio lighting.”
“Show a pair of running shoes with a custom reflective stripe and a logo on the heel, rotating in a 3D view.”

Generally, for Accessories Customization:
“Generate a synthetic image of a leather handbag with a gold-embossed ‘MK’ logo on the front flap.”
“Create a video of a wristwatch with a custom engraving ‘Forever Yours’ on the back plate, displayed in a close-up rotating view.”
“Show a baseball cap with a custom embroidered team logo on the front, displayed in a video with dynamic lighting.”

Generally, for Home Decor Customization:
“Generate a synthetic image of a throw pillow with a custom floral pattern in pastel colors.”
“Create a video of a ceramic mug with a custom ‘World's Best Dad’ text and a photo of a family, rotating under warm lighting.”
“Show a wall clock with a custom company logo on the face, displayed in a 3D video with a zoom-in effect.”

Generally, for Sports Equipment Customization:
“Generate a synthetic image of a basketball with a custom team logo and the text ‘Champions 2025’ in gold.”
“Create a video of a tennis racket with a custom grip design and a player's name engraved on the frame, rotating in a 3D view.”
“Show a football jersey with a custom player name and number, displayed in a video with dynamic lighting.”

Generally, for Jewelry Customization:
“Generate a synthetic image of a gold necklace with a custom pendant in the shape of a heart, engraved with ‘Love Always.’”
“Create a video of a diamond ring with a custom inscription ‘Forever Together’ on the inner band, rotating under soft lighting.”
“Show a pair of earrings with a custom gemstone color and a floral design, displayed in a close-up video.”

These prompts demonstrate the system's flexibility in handling a wide range of product types and customization options, allowing users to visualize their designs in both static and dynamic formats.

### 16.6. Examples of AI-Based Image Generators

Non-limiting examples of AI-based image generators that could be used to generate individual AI-based images include: github.com/black-forest-labs/flux, huggingface.co/stabilityai/stable-diffusion-xl-base-1.0, and deepmind.google/technologies/imagen-3/.

Non-limiting examples of the AI-based image generators that could be used to generate video sequences may include: github.com/Wan-Video/Wan2.1, github.com/Tencent/HunyuanVideo, and github.com/Lightricks/LTX-Video.

### 16.7. Generating Synthetic Videos

### 16.7.1. First Example

FIG. 1K depicts a process of generating a dynamic composite video. More specifically, FIG. 1K shows a process of generating a dynamic composite video, represented as a sequence of frames that collectively form a first video sequence 1K100. The figure illustrates the progression of frames, each contributing to the overall animation or motion within the video sequence.

The first frame, 1K102, serves as the initial input frame, capturing the starting point of the video sequence. This frame includes a depiction of a customizable product, such as a garment, with a specific design or pattern applied to the surface of the garment. The design remains consistent across subsequent frames, ensuring continuity in the visual representation of the product.

The second frame, 1K104, follows the first frame, introducing a slight variation in the product's orientation or perspective. This transition between frames simulates motion or interaction, contributing to the dynamic nature of the video sequence.

The third frame, 1K106, continues the progression, further refining the depiction of the product. The frame maintains the integrity of the design while adjusting the visual elements to align with the intended motion or perspective shift.

The fourth frame, 1K108, builds upon the preceding frames, ensuring a smooth transition in the sequence. This frame showcases the system's adaptability in preserving design details while accommodating changes in the product's orientation or position.

The fifth frame, 1KI10, concludes the illustrated portion of the video sequence, demonstrating the final stage of dynamic composite video generation. The frame ensures that the design remains visually coherent and realistic, enhancing the overall quality of the video sequence.

The sequence of frames 1K102, 1K104, 1K106, 1K108, and 1K110 collectively illustrates the system's ability to generate a dynamic video representation of a customizable product. This process leverages advanced techniques, such as generative artificial intelligence and interpolation methods, to ensure smooth transitions and high fidelity in the resulting video.

### 16.7.2. Second Example

FIG. 1L depicts another process of generating a dynamic composite video. More specifically, FIG. 1L shows a process for generating a dynamic composite video by illustrating a sequence of frames that collectively form a second video sequence 1M100. Each frame in the sequence represents a distinct stage in the video's progression, highlighting the dynamic transformation of the visual content. In comparison to FIG. 1K, FIG. 1L includes more frames than FIG. 1K.

The first frame, 1M102, serves as the initial frame in the sequence, depicting the video's starting point.

The second frame, 1M104, through the ninth frame, 1M118, represent subsequent frames in the sequence, each capturing incremental changes in the visual representation of the subject. These frames collectively demonstrate the transition and motion within the video, showcasing the application of generative techniques to create a smooth and coherent animation.

The second video sequence, 1M100, is generated by leveraging advanced generative artificial intelligence systems. These systems utilize input data, such as a single static image or a set of static images, to produce a series of frames that simulate motion. The frames are synthesized to maintain consistency in visual elements, such as lighting, texture, and geometry, ensuring a realistic and seamless video output.

The sequence depicted in FIG. 1L highlights the application of quadrilateral grid interpolation and inpainting techniques. These methods are employed to refine the visual details across frames, preserving the integrity of the underlying design while dynamically transitioning between frames. Additionally, lighting and specular effects may be incorporated into the frames to enhance the realism of the video sequence.

This process enables the creation of interactive assets that can be utilized for various applications, including product visualization, customization, and marketing. By generating a dynamic video sequence from static inputs, the system provides a scalable and efficient solution for producing high-quality video content.

### 17.0. Quadrilateral Interpolation Approach

In some implementations, a markup region is interpolated using a quadrilateral grid and an image's alpha channel. An alpha channel represents the degree of opacity (also defined as transparency) of a computer-generated image, video footage, or the bump, displacement, or opacity properties of a 3D texture. Alpha compositing or alpha blending is the process of combining one image with a background to create the appearance of partial or full transparency.

An interpolation process using a quadrilateral grid and an alpha channel may include the following steps:
1) As input:
   a) Take an image with an alpha channel showing a rectangle mapped onto a 3D surface, such as a T-shirt, towel, or drape.
   b) Take the number of rows and columns needed to construct a quadrilateral grid.
2) Vectorize the shape found in the alpha channel.
   a) Use uniform distance sampling.
   b) Each point on the path is roughly equidistant from its neighboring points.
3) Determine the corners of the vector path.
   a) Find the centroid of the path by averaging the vector path points.
   b) Find the farthest point from the centroid, this is v0.
   c) Find the farthest point from the first corner, this is the v2.
   d) Find the positive farthest point from the line v0-v2, this is v1.
   e) Find the negative farthest point from the line v0-v2, this is v3.
      i) The corners are points: v0, v1, v2, v3 in winding order.
4) Correct the winding order of the vector path so it is clockwise.
   a) If the surface normal of the poly v0, v1, v2, v3 is negative, reverse the order of the points.
5) Correct the orientation of the poly.
   a) Rotate the point order so that v0 is closest to the upper left corner of the image frame.
6) Set each sub-path of the quadrilateral grid using the found corners.
   a) Top is Sub path v0-v1.
   b) The Right Side is Sub path v1-v2.
   c) Bottom is Sub path v3-v2.
   d) The Left Side is Sub path v0-v3.
7) Resample the Sub paths.
   a) Resample sub path v0-v1, and v3-v2 to have the input number of columns.
   b) Resample sub paths v1-v2 and v0-v3 to have the input number of rows.
8) Sample the quadrilateral grid:
   a) For each u, v element in the column by row numbered grid.
      i) Calculate the element's v interpolant (vi):
         (1) Interpolate between v0-v1[u] and v0-v1[u] by v/rows.
      ii) Calculate the element's U interpolant (ui):
         (1) Interpolate between v1-v2[v] and v0-v3[v] by u/columns.
   b) Determine the weight for the u element (uw).
      i) Let i=v/rows.
      ii) Let uw=power(i, 3)+power(1−i, 3).
   c) Determine the weight for the v element (vw).
      i) Let i=u/columns.
      ii) Let vw=power(i, 3)+power(1−i, 3).
   d) Weight and set the u,v element:

$$i ) Element u , v = ( ( uw * ui ) + ( vw * vi ) ) / ( uw + v w ) .$$

e) Note that this adjusts the interpolated values of each element by the distance from the contributing edges.

TABLE 1 below is a graph showing the weight contribution (vertical axis) based on the position of a value in the mesh (horizontal axis) at positions 1 through 11. On either side of the mesh (i.e., positions 1 and 11), the value of the mesh at that position fully contributes to the overall value of the mesh.

### 18.0. Example Computer Environments

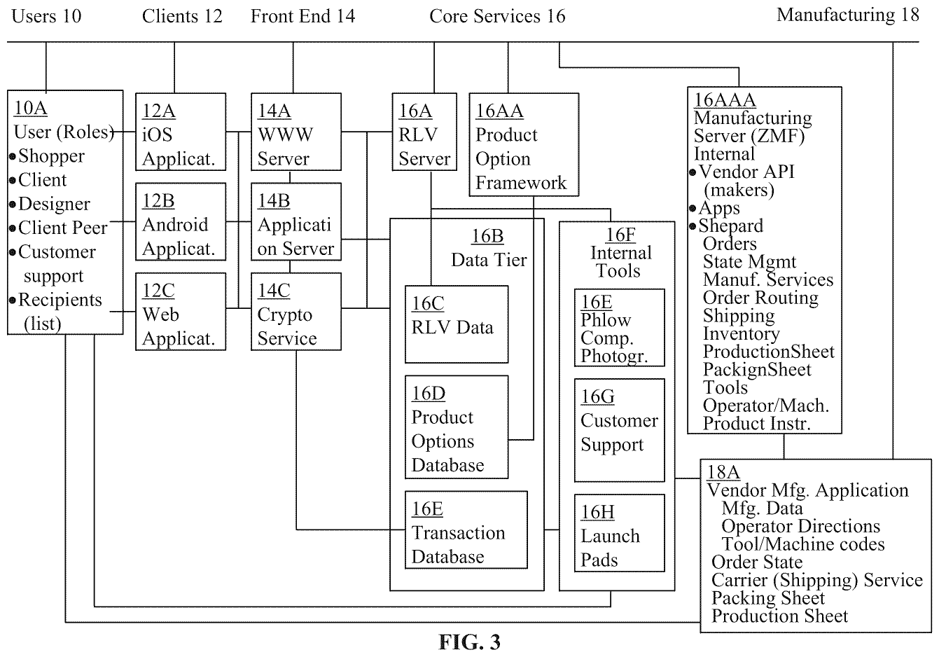

In some embodiments, the presented approach is implemented in a computer-based platform. The platform allows users, designers, customers, and support engineers to, for example, design and create digital product designs. FIG. 3 describes a computer environment for creating digital designs, manufacturing products, and the like.

A digital design for a product may be captured in, for example, product description data. A hyperlink to the specific location can be created and transmitted from the collaboration platform to a manufacturing server, causing the server to generate a final product based on the digital design.

A product may be digital, such as a digital gift card, or a combination of physical and digital, such as a physical or digital t-shirt.

FIG. 3 is a block diagram showing an example computer environment. In FIG. 3, users 10 are individuals who create and design digital designs of products; clients 12 correspond to software applications configured to facilitate communications between users 10 and front-end servers 14; core services 16 correspond to software applications and tools configured to facilitate creating and designing of the digital designs and generating manufacturing instructions for manufacturing final products based on the digital designs; and manufacturing 18 corresponds to manufacturing servers and applications configured to manufacture, or cause manufacturing, the final products, and the like.

Each user 10 may use its own or a shared computer device. In some embodiments, examples of user 10 are determined based on the roles that may be assigned to the users. Examples 10A of roles may include a shopper, a client, a designer, a client peer, a customer support engineer, a recipient, and the like.

Clients 12 in FIG. 3 refer to client applications implemented in client servers 14 and configured to support requests received from users 10A. Non-limiting examples of clients 12 may include iOS applications 12A, Android applications 12B, Web applications 12C, and the like.

Front and end servers 14 refer to computer-based servers configured to process requests received from clients 12 and, in many cases, interact with core services 16 to resolve these requests further. Examples of front-end servers 14 include one or more WWW servers 14A, one or more application servers 14B, and one or more cryptographic servers 14C. Cryptographic servers 14C may be configured to provide cryptographic services for encrypting/decrypting, transmitting, or otherwise communicating data between the entities depicted in FIG. 1.

Core services 16 in FIG. 3 refer to servers and services implemented in a role-based collaboration platform configured to provide functionalities for creating and designing digital designs, handling collaboration requests, and facilitating the customization requests received from users 10.

In some embodiments, a customization process performed by a user, such as user 10, intended to generate a digital design of a customized product, is captured in so-called product description data, which may be translated into a manufacturing description comprising product and manufacturing instructions.

The product and manufacturing instructions may include digital design specifications, data, and code needed to manufacture a custom product. That may include instructions for generating, for example, a 3D geometry for digital final products. This may also include generating instructions for creating 2D and 3D patterns that can be used to cut, cast, or form physical or digital components of final products. The patterns may be parametric, i.e., they may have parameters that, through encoded relationships, adjust the form of the pattern for a specific need.

For instance, a set of 2D patterns for a t-shirt graded based on size may be converted into a parametric pattern by interpolating the grade curvatures. A single parametric value, typically referred to as a ‘size,’ can set the automatic grading.

The product instructions may also include 2D and 3D models used to form, through additive manufacturing or subtractive manufacturing, portions of a product. The models may be parametric, i.e., they may have parameters that, through coded relationships, adjust the model's form to meet a specific need. For instance, a set of 3D models may represent a bike helmet. Each model may fit a statistically normed human head of a particular age. A coded relationship between the models may allow for interpolating the set of models for a specific age. A single parametric value may set the automatic interpolation. The single parametric value, in this case, is usually called an ‘age.’

The product instructions may also include material properties, such as the physical or digital material used to form a product from a pattern. Some material properties may be parametric, i.e., they may be selected or changed during manufacturing.

The properties may also include a body color. For instance, the color of a fabric may be selected for manufacturing a t-shirt. According to another example, the plastic color may be chosen for manufacturing a bike helmet.

The properties may also include a body texture, such as the fabric weave of a t-shirt, which can be specified as either smooth or slubby. For instance, the surface of a plastic bike helmet may be polished or satin. Each property is necessarily specific to each class of materials. Examples of materials and properties may include a fabric (such as a weave or knit type, a fiber type (e.g., cotton, wool, flax, polyester, polypropylene), a thread size, a thread count, a color, an integral design (e.g., ikat, knit, tapestry, etc.), a bolt width, a selvage type, a surface (e.g., hand), and the like.

Referring again to FIG. 3, in some embodiments, core services 16 refer to services implemented in a role-based collaboration platform. In the example, core services 16 may be provided by one or more real-view (RLV) servers 16A and a product option framework 16AA. RLV servers 16A and product options framework 16AA may use one or more data tier databases 16B, including RLV Data 16C, a product options database 16D, a transaction database 16E, and the like.

In some embodiments, core services 16 may also utilize internal tools 16F, such as computational photographic tools 16E, customer support tools 16G, launch pads tools 16H, etc.

Product option framework 16AA is also called a persistent design data framework. The framework data may include a product options set, which may include a set of product options pertaining to a specific product type. It usually contains the product instructions (e.g., collaboration components 106 in FIG. 2) for manufacturing or producing the product.

In some embodiments, product options framework 16AA is configured to provide services for transforming ProductOption key/value pairs (i.e., manufacturing constraints) from one product to another. Transforming the ProductOption key/value pairs from one product to another may require, for example, transforming the color space (i.e., sRGB to CMYK US Web Coated (SWOP) v2), converting an image from raster to vector, and resizing the image to fit the new product.

In some embodiments, the product option set includes logic to enumerate each customizable option in a manner that presents a complete user interface for changing the parametric product instructions.

The instructions for manufacturing a customized product are usually parametric. The parameters include the size of the customized product (this can be multi-dimensional and include width, height, and depth). The parameters may also relate to human size or age. The parameters may also be custom and based on biometric information.

In some embodiments, a product option may be represented as a key-value pair. The key/value pair is a label that may span individual products and represent a class of products. The keys of pairs may include a material type, a color, a size, and other similar details.

The value in a key/value pair is a specific discrete or continuous value that sets a manufacturing instruction. Examples of discrete (enumerated) values may include a discrete type of fabric such as cotton, cotton-polyester blend, silk, and the like. The discrete values may also include specific colors, such as white, navy, black, and the like.

Examples of continuous values of key/value pairs may include a single element, such as length or a ribbon, a vector, such as the size of a frame for a print (width (in inches) or height (in inches)), or the size of a box for the European countries, such as a size of a box for the EU (width (in millimeters), height (in millimeters), depth (in millimeters)).

The values may also reference a known file type, such as an image for the t-shirt design, an embroidery file for the back of a jacket, an engraving design for a bracelet, and the like.

In some embodiments, values in key/value pairs may include a set of graphic primitives for a design, such as an image, a line, a circle, a rectangle, a text, a group, and the like.

The product option key values may have default values. Default values are pre-set values that produce a product without requiring any customization of key/value pairs. When key values are changed, they may produce a product option framework event chain. A product options framework event chain is a journal of each key-value change ordered in time.

A product option key-value may represent a product type. Using this option type, one product type may be associated with another through a well-known relationship.

In some embodiments, a product options framework event chain includes one or more products, and the chain may represent or memorialize an event that has occurred. The products may represent or memorialize an event. Examples of events include weddings, birthdays, anniversaries, graduations, national holidays, reunions, and similar celebrations.

In some embodiments, a product option set event chain includes a key-value pair that encodes the product at the end of the chain. For example, an invitation may be chained to an RSVP card. A key-value may also encode the role of the chained event. For example, a chained RSVP card key-value may include the recipient of the invitation as the sender role for the RSVP card.

A key-value pair may also encode the shared properties used to set the chained product's properties. For instance, a design for the invitation may be shared with the RSVP card. A key-value may also encode the timing for the chained product. Typically, the event chain properties are custom (e.g., parametric), and a product designer may change them to fit a specific product set.

In an embodiment, a product option framework is configured to generate its user interface. Accordingly, each product option set is associated with logic and code to build a user interface element for each parametric product option. Furthermore, each product option set contains style hints, allowing each user interface element to be artfully placed and produce a high-quality user experience.

Typically, user interface elements are designed to match each class of values in all products covered by a product options framework. New user interface elements may be added as the product categories expand. The user interface elements may include a design view, a color editor, a font editor, a size selector, a texture selector, a text editor, a fabric swatch selector, a product configurable image, and the like.

In some embodiments, a product options framework cooperates with a user product renderer, which may be implemented, for example, in a RealView server 16A. The user product renderer may be configured to render views of a custom product as it is already manufactured. Typically, it uses a product option set of key-values as input. It creates one or more run-time assets using computational photography of the manufactured product.

### 19.0. Generating and Refining Synthetic Images of Customizable Products

### 19.1. Overview

In some implementations, a core service receives a text prompt describing a product and a desired markup, generating a synthetic image of the product with the markup using a generative AI system, validating the synthetic image against physical product specifications to ensure conformity; mapping the synthetic image onto a 3D surface using quadrilateral grid interpolation; applying inpainting techniques to remove the markup while preserving underlying fabric details; incorporating lighting and specular effects to enhance the realism of the synthetic image; integrating the enhanced synthetic image into an interactive asset for customizable product visualization; providing the interactive asset for user interaction and customization before manufacturing.

Another aspect of the method is that it comprises text prompts with specific product attributes such as color, size, or material.

The method comprises a generative AI system utilizing different AI models for generating synthetic images.

Another aspect of the method is comparing the synthetic image with a database of physical product specifications for validation.

According to another aspect, the method comprises mapping the synthetic image onto a 3D surface employing alternative interpolation methods.

According to another aspect, the method comprises the inpainting techniques using texture synthesis algorithms to preserve additional product details.

According to another aspect, the method further simulates various lighting scenarios, including natural and artificial light, to enhance realism.

According to another aspect, the method comprises an interactive asset that enables real-time customization of the synthetic image.

In another aspect, the method allows users to modify product features directly within the interactive asset.

According to another aspect, an apparatus for generating and refining synthetic images of customizable products comprises a generative AI system configured to create synthetic images with digital markups based on user inputs; a validation and correction module configured to validate and correct the synthetic images to ensure conformity with physical product specifications; a 3D mapping and image synthesis module configured to map user images onto 3D surfaces using quadrilateral grid interpolation; an inpainting module configured to remove digital markups from the synthetic images while preserving underlying fabric details; an interactive asset creation system configured to integrate the synthetic images into interactive assets for customizable product visualization and manufacturing; depth estimation and normal mapping tools configured to refine a placement and appearance of digital markups on 3D models; a lighting and specular effects module configured to apply lighting and specular effects to enhance the realism of the synthetic images.

In another aspect, the apparatus comprises the generative AI system, which is further configured to accept text and image inputs for enhanced customization.

The apparatus comprises the generative AI system configured to generate multiple design variations for user selection.

The apparatus further comprises the validation and correction module, incorporating machine learning algorithms to improve accuracy over time.

The apparatus also comprises the validation and correction module, which provides a report of discrepancies between synthetic and physical specifications.

Another aspect of the apparatus is that it comprises a 3D mapping and image synthesis module, utilizing alternative interpolation methods for different surface types, such as spline interpolation.

In another aspect, the apparatus comprises a 3D mapping and image synthesis module that supports multiple file formats for compatibility with various design software.

Furthermore, the apparatus comprises an inpainting module that employs advanced texture synthesis techniques to maintain fabric continuity.

The apparatus also comprises the inpainting module, which offers customizable inpainting parameters for user-defined detail preservation.

According to yet another aspect, a non-transitory, computer-readable storage medium storing one or more computer instructions which, when executed by one or more computer processors, cause the one or more computer processors to perform receiving a text prompt describing a product and a desired markup; generating a synthetic image of the product with the markup using a generative AI system; validating the synthetic image against physical product specifications to ensure conformity; mapping the synthetic image onto a 3D surface using quadrilateral grid interpolation; applying inpainting techniques to remove the markup while preserving underlying fabric details; incorporating lighting and specular effects to enhance the realism of the synthetic image; integrating the enhanced synthetic image into an interactive asset for customizable product visualization; providing the interactive asset for user interaction and customization prior to manufacturing.

### 19.2. Example Flow Chart for Generating and Refining Synthetic Images of Customizable Products

FIG. 4A is a flow chart depicting an example process for generating and refining synthetic images of customizable products. The example process described in FIG. 4A may be executed by one or more components of core services 16, described later. For simplicity of the description, it is assumed that the steps described in FIG. 4A is performed by a core service.

In step 400, a core service receives a text prompt describing a product and a desired markup. The text prompt may include specific product attributes such as color, size, or material.

In step 402, the core service generates a synthetic image of the product with the markup using a generative AI system. The generative AI system may utilize different AI models to generate synthetic images.

Also, in this step, the core service validates the synthetic image against physical product specifications to ensure conformity.

In step 402A, the core service tests whether the validation is successful, i.e., whether the synthetic image conforms to the physical product specifications. If this is the case, then the core service proceeds to step 404. Otherwise, the core service generates a new synthetic image and performs the validation of the new synthetic image against the physical product specification.

In step 404, the core service maps the synthetic image onto a 3D surface using quadrilateral grid interpolation. Mapping the synthetic image onto a 3D surface employs alternative interpolation methods in some embodiments.

Also, in this step, the core service applies inpainting techniques to remove the markup while preserving underlying fabric details. In some embodiments, the inpainting techniques use texture synthesis algorithms to preserve additional product details.

In step 406, the core service incorporates lighting and specular effects to enhance the realism of the synthetic image. Also, in this step, the core service integrates the enhanced synthetic image into an interactive asset for customizable product visualization. In some embodiments, the interactive asset enables real-time customization of the synthetic image.

In step 408, the core service checks whether the enhanced synthetic image has been successfully integrated into the interactive asset for customizable product visualization. If it has, then the core service performs step 410. Otherwise, the core service repeats step 406.

In step 410, the core service provides the interactive asset for user interaction and customization prior to manufacturing.

In some embodiments, the method comprises comparing the synthetic image with a database of physical product specifications for validation. The method further includes simulating various lighting scenarios, such as natural or artificial light, to enhance realism. The method may also include allowing users to modify product features directly within the interactive asset.

### 20.0. Generating and Validating Digital Markups on Customizable Products

### 20.1. Overview

In some embodiments, a computer-implemented method for generating and validating digital markups on customizable products begins with a textual prompt describing the product and the desired markup. This prompt can be input through various user interfaces, such as web applications, mobile apps, or voice-activated systems, allowing for flexibility in how users interact with the system. The generative AI model, a neural network trained on a diverse dataset of customizable products, generates a synthetic image of the product with the specified markup. This model may utilize different generative AI techniques, including Generative Adversarial Networks (GANs) or transformer-based models, to create high-fidelity images.

In another embodiment, the synthetic image undergoes a validation process in which it is compared against known product metrics to ensure that it meets the physical specifications. This validation can include checking the placement and size of the markup against predefined product dimensions to ensure the design is feasible for manufacturing. Advanced image segmentation techniques, such as deep learning-based methods, isolate and recognize specific markup regions within the synthetic image. This segmentation can support multi-layer designs, allowing for complex and detailed customizations.

The synthetic image is refined following validation to correct any discrepancies identified during the validation process. This refinement may involve adjusting the markup's color and position based on feedback from the validation step. The refined image is then normalized to match a standard color profile, ensuring consistency across viewing and manufacturing environments.

The method generates detailed manufacturing instructions based on the refined synthetic image in another embodiment. These instructions can specify various aspects of the production process, such as printing techniques, materials to be used, and other relevant parameters. The manufacturing instructions are then provided to a manufacturing system, such as a 3D printer, a CNC machine, or other suitable production equipment, to produce the customizable product. The refined synthetic image can also be displayed on a user interface for review before production, allowing users to make final adjustments or approve the design.

These embodiments demonstrate the system's adaptability within the legal and functional scope defined by the patent claims, showcasing the system's ability to handle various input methods, utilize advanced AI techniques, and integrate seamlessly with different manufacturing systems.

### 20.2. Example Flow Chart for Example Flow Chart for Generating and Validating Digital Markups on Customizable Products

FIG. 4B is a flow chart depicting an example process for generating and validating digital markups on customizable products. For simplicity of the description, it is assumed that the steps described in FIG. 4B is performed by a core service.

In step 420, a core service receives a textual prompt that describes a product and its markup.

In step 422, the core service generates a synthetic image of the product with the markup using a generative AI model. In some embodiments, the generative AI model is a neural network trained on a dataset of customizable products.

Also, in this step, the core service validates the synthetic image by comparing it with known product metrics to ensure conformity with physical specifications. In some embodiments, the validation includes checking the placement and size of the markup against predefined product dimensions.

In step 422A, the core service tests whether the validation is successful, i.e., whether the synthetic image conforms to the physical product specifications. If this is the case, then the core service proceeds to step 424. Otherwise, the core service generates a new synthetic image and performs the validation of the new synthetic image against the physical product specification.

In step 424, the core service isolates and recognizes specific markup regions within the synthetic image.

Also, in this step, the core service refines the synthetic image based on the validation results to correct any discrepancies. In some embodiments, the refining involves adjusting the markup's color and position based on validation feedback.

In step 426, the core service generates manufacturing instructions based on the refined synthetic image for producing the customizable product. In some embodiments, the manufacturing instructions include details on printing techniques and materials to be used.

In step 428, the core service checks whether all necessary manufacturing instructions for producing the customizable product have been generated. If they have, then the core service proceeds to step 430. Otherwise, the core service repeats step 426.

In step 430, the core service provides the manufacturing instructions to a manufacturing system, which then manufactures the customizable product.

In some embodiments, the method further comprises normalizing the synthetic image to match a standard color profile before the validation. The method may also include image segmentation techniques to isolate the markup regions. Furthermore, the method may include displaying the refined synthetic image on a user interface for review before production.

### 21.0. Generating a Quadrilateral Grid from an Image Alpha Channel

### 21.1. Overview

In one embodiment, a computer-implemented method for generating a quadrilateral grid from an image with an alpha channel involves receiving an image that depicts a shape mapped onto a 3D surface, where the image is processed to vectorize the shape found in the alpha channel, creating a vector path. The method then determines the corners of the vector path by calculating the centroid of the vector path and identifying the points from the centroid to establish corner points. The winding order and orientation of the vector path are corrected to ensure a clockwise order. A quadrilateral grid is constructed by setting sub-paths based on the detected corners, and these sub-paths are resampled to match a specified number of rows and columns. Weighted interpolation is performed across the grid by calculating interpolants for each grid element based on inverse square distance weighting and adjusting interpolated values by the distance from contributing edges. The generated quadrilateral grid is then output and displayed on a computer display device.

In other embodiments, the method includes normalizing the vector path to fit within a predefined coordinate system, ensuring that the shape is accurately represented regardless of the original dimensions or orientation. This normalization process enables consistent grid generation across various images and shapes.

In a further embodiment, the vectorizing process includes smoothing the vector path using a spline interpolation, which enhances the accuracy and smoothness of the generated grid by reducing jagged edges and irregularities in the vector path.

Additionally, the centroid calculation can be performed by averaging the coordinates of the points along the vector path, providing a simple yet effective method for determining the central point of the shape.

To verify the clockwise order, the method includes calculating the 3D surface's orientation of the quadrilateral, ensuring that the grid is correctly oriented in 3D space.

Resampling the sub-paths can involve linear interpolation to distribute points evenly, which helps maintain a uniform grid structure.

For enhanced accuracy, weighted interpolation may utilize cubic weighting functions, resulting in more precise interpolant calculations than those obtained with straightforward methods.

The generated quadrilateral grid can be displayed on a graphical user interface, enabling users to interact with and manipulate the grid in real-time. This embodiment showcases the method's adaptability and precision in generating accurate quadrilateral grids from images with alpha channels, making it suitable for various applications in computer graphics and 3D modeling.

### 21.2. Example Flow Chart for Generating a Quadrilateral Grid from an Image Alpha Channel

FIG. 4C is a flow chart depicting an example process for generating a quadrilateral grid from an image with an alpha channel. For simplicity of the description, it is assumed that the steps described in FIG. 4C is performed by a core service.

In step 440, a core service receives an image with an alpha channel depicting a shape mapped onto a 3D surface. Also, in this step, the core service vectorizes the shape found in the alpha channel to create a vector path. In some embodiments, the vectorizing includes smoothing the vector path using a spline interpolation.

In step 442, the core service determines the corners of the vector path by calculating the centroid of the vector path. In some embodiments, the centroid is calculated by averaging the coordinates of the points along the vector path.

Also, in this step, the core service identifies the farthest points from the centroid to establish corner points.

In step 444, the core service corrects the winding order and orientation of the vector path to ensure a clockwise order. Also, in this step, the core service constructs a quadrilateral grid by setting sub-paths based on detected corners.

In this step, the core service also resamples the sub-paths to match a specified number of rows and columns. In some embodiments, resampling the sub-paths involves linear interpolation to distribute points evenly.

In step 446, the core service performs weighted interpolation across the grid by calculating interpolants for each grid element based on inverse square distance weighting. In some embodiments, the weighted interpolation uses cubic weighting functions for enhanced accuracy.

Additionally, in this step, the core service adjusts interpolated values based on the distance from contributing edges.

In step 448, the core service checks if the distance from contributing edges has adjusted all interpolated values. If they have, then core service performs step 450. Otherwise, the core service repeats step 446.

In step 450, the core service outputs the generated quadrilateral grid. Additionally, in this step, the core service displays the generated output of the quadrilateral grid on a computer display device.

In some embodiments, the method further comprises normalizing the vector path to fit within a predefined coordinate system. The method may also include verifying the clockwise order by calculating the 3D surface's normal of the quadrilateral. Furthermore, the method comprises displaying the generated quadrilateral grid on a graphical user interface.

### 22.0. Generating Continuous Video Motion Sequences from AI-Processed Images

In some implementations, the component 460 initiates the process by receiving a text prompt that describes a product and a markup. The text prompt may include specific attributes of the product, such as color, size, material, or other distinguishing features, as well as details about the markup, such as a logo, text, or graphical design to be applied to the product. This input serves as the basis for generating a synthetic image of the product with the specified markup.

A generative AI system is employed to process the text prompt and create the synthetic image. The generative AI system may utilize advanced natural language processing (NLP) models to interpret the text prompt and extract relevant details. These details are then used to guide the image generation process. The generative AI system may include diffusion models, generative adversarial networks (GANs), or other state-of-the-art AI architectures capable of producing high-quality synthetic images. The system may also incorporate pre-trained models fine-tuned on datasets containing images of similar products and markups to enhance the accuracy and realism of the generated image.

The synthetic image generated by the generative AI system is designed to visually represent the product with the specified markup applied. This image serves as the input for subsequent processing steps, ensuring that the product's visual representation aligns with the user's requirements as described in the text prompt. The generative AI system may also support iterative refinement, allowing users to modify the text prompt and regenerate the synthetic image to achieve the desired outcome.

### 22.1. Example Flow Chart for Generating Video Sequences

FIG. 4D is a flow chart depicting an example process for generating video sequences. More specifically, FIG. 4D illustrates a flowchart that shows an example process for generating video sequences of customizable products using a generative artificial intelligence system. The process involves multiple stages, each contributing to the creation of a realistic and interactive video representation of a product.

The component 460 initiates the process by receiving a text prompt that describes a product and a markup. The text prompt may include specific attributes of the product, such as color, size, material, or other distinguishing features, as well as details about the markup, such as a logo, text, or graphical design to be applied to the product. This input serves as the basis for generating a synthetic image of the product with the specified markup.

A generative artificial intelligence system is employed to process the text prompt and create the synthetic image. The generative AI system may utilize advanced natural language processing (NLP) models to interpret the text prompt and extract relevant details. These details are then used to guide the image generation process. The generative AI system may include diffusion models, generative adversarial networks (GANs), or other state-of-the-art AI architectures capable of producing high-quality synthetic images. The system may also incorporate pre-trained models fine-tuned on datasets containing images of similar products and markups to enhance the accuracy and realism of the generated image.

The synthetic image generated by the generative AI system is designed to visually represent the product with the specified markup applied. This image serves as the input for subsequent processing steps, ensuring that the product's visual representation aligns with the user's requirements as described in the text prompt. The generative AI system may also support iterative refinement, allowing users to modify the text prompt and regenerate the synthetic image to achieve the desired outcome.

The component 462 performs an important validation step to ensure that the synthetic image generated in component 460 aligns with the physical specifications of the product. This validation process involves comparing the synthetic image against a database of physical product specifications, which may include dimensions, material properties, and design constraints. The validation ensures that the synthetic image accurately represents a feasible and manufacturable version of the product.

Once the synthetic image is validated, it is mapped onto a 3D surface to create a three-dimensional representation of the product. This mapping process employs quadrilateral grid interpolation techniques to project the synthetic image onto the 3D surface. Quadrilateral grid interpolation ensures that the synthetic image is accurately aligned with the contours and geometry of the 3D model, preserving the product's proportions, details, and markup. The 3D surface may be a pre-defined model of the product, stored in a database, or dynamically generated based on the product specifications.

The mapping process facilitates the transition from a two-dimensional synthetic image to a three-dimensional interactive asset, enabling further processing and visualization. This step plays a significant role in creating a realistic and interactive representation of the product, which can be used for customization, visualization, and manufacturing purposes.

The component 464 begins by applying inpainting techniques to the synthetic image to remove the markup while preserving the underlying fabric or material details of the product. Inpainting techniques may include advanced texture synthesis algorithms that reconstruct the areas of the image where the markup was removed, ensuring that the original texture, color, and patterns of the product are seamlessly restored. These techniques are beneficial for creating a clean base image that can be further enhanced.

Next, the component generates an enhanced synthetic image by incorporating lighting and specular effects. These effects simulate realistic lighting conditions, such as natural or artificial light, and add depth and dimensionality to the image. Specular effects, such as reflections and highlights, are applied to mimic the interaction of light with the product's surface, enhancing the visual realism of the synthetic image. The lighting and specular effects are dynamically adjusted based on the product's material properties and the intended viewing conditions.

Using quadrilateral grid interpolation, the enhanced synthetic image is mapped onto the three-dimensional surface of the product to create an interactive asset. This interactive asset provides a dynamic representation of the product, enabling users to view and manipulate it in a three-dimensional space. The interactive asset is subsequently utilized as the foundation for generating a video frame sequence. The generative AI system generates the video frame sequence by simulating motion and transitions, ensuring that each frame depicts the interactive asset alongside the enhanced synthetic image. The video frame sequence provides a dynamic and engaging visualization of the product, highlighting its features and customization options.

The component 466 processes each frame of the video frame sequence generated in component 464 to create a vector data file for the interactive asset. The vector data file contains detailed information about the geometry, vertices, and other attributes of the interactive asset depicted in the frame. This data plays a significant role in accurately representing the interactive asset in a scalable and editable format, enabling further customization and manipulation.

A video data file is then generated based on the vector data files for each frame of the video frame sequence. The video data file consolidates the frame-by-frame information into a cohesive video format, ensuring that the interactive asset is accurately represented throughout the sequence. The video data file may be encoded in standard formats, such as MP4 or AVI, to ensure compatibility with various playback and editing tools.

In addition to the video data file, customization instructions are generated to enable users to modify the appearance of the interactive asset. These instructions may include parameters for adjusting colors, textures, lighting, and other visual attributes of the interactive asset. The customization instructions are designed to be user-friendly, allowing users to easily apply changes and preview the results in real-time.

The component 468 serves as a decision point in the process flow. The component determines whether the generation and customization of the interactive asset, along with the associated video frame sequence, have been completed. If the process is not complete, the system may loop back to earlier components to address any issues or perform additional processing. If the process is complete, the system advances to the subsequent step.

The component 470 finalizes the process by transmitting the video data file and the customization instructions to a manufacturing entity. The manufacturing entity uses this information to render the interactive asset, ensuring that the final product aligns with the user's specifications. The transmission may occur over a secure network connection to maintain the integrity and confidentiality of the data.

The video data file provides a visual reference for the manufacturing entity, while the customization instructions specify the exact parameters for producing the product. This combination of visual and technical data ensures that the manufacturing process is accurate and efficient, reducing the likelihood of errors and ensuring customer satisfaction.

### 23.0. Example Benefits of the Present Approach

The approach presented herein offers several significant benefits, including the enhancement of synthetic image generation and refinement for customizable products. More specifically, the benefits include cost and time efficiency. The present approach eliminates the need for physical prototypes and extensive photography sessions by utilizing generative AI to create synthetic images. This significantly reduces the time and cost associated with traditional product visualization and customization methods.

Another benefit includes the high accuracy and realism of the generated images. The validation and correction module ensures that synthetic images conform to physical product specifications, enhancing the accuracy and reliability of the generated images. The incorporation of lighting and specular effects, along with advanced inpainting techniques, further enhances the realism of the synthetic images, making them visually indistinguishable from actual photographs.

Additional benefits include the flexibility and adaptability of the markup process. The system's ability to accept text and image inputs, utilize different AI models, and employ various interpolation methods allows for high flexibility and adaptability in generating markups. This ensures the system can handle multiple product types, shapes, and customization requirements, catering to diverse user needs.

The benefits also include real-time customization: integrating synthetic images into interactive assets enables users to customize in real-time. This interactive feature allows users to modify product features directly, offering a highly engaging and personalized experience. Users can immediately see the effects of their customizations, ensuring that the final product meets their specifications.

Additional benefits include enhanced user experience. The system's ability to generate multiple design variations and offer customizable inpainting parameters provides users with a wide range of options and greater control over the final appearance of their products. This enhances the overall user experience, resulting in higher satisfaction and more informed purchasing decisions.

The benefits also include continuous improvement in the markup-generating process. Incorporating machine learning algorithms into the validation and correction module enables the system to improve its accuracy over time. Learning from past corrections and user feedback makes the system more reliable and effective in generating high-quality synthetic images.

The system also includes seamless integration. The system's ability to integrate synthetic images into existing workflows and processes ensures seamless adoption and implementation. The generated images can be utilized in various applications, including online product configurators, marketing materials, and virtual try-on experiences, thereby enhancing product customization, visualization efficiency, and effectiveness.

The approach also offers reduced environmental impact. The approach reduces resource consumption and waste by eliminating the need for physical prototypes and reducing reliance on traditional photography. This environmentally friendly approach aligns with sustainable business practices, helping to reduce the overall environmental impact of product customization processes.

Overall, the present approach provides a comprehensive and technologically advanced solution for generating and refining synthetic images of customizable products, offering significant benefits in terms of cost efficiency, accuracy, flexibility, user experience, and environmental sustainability.

### 24.0. Implementation Mechanisms

Although the flow diagrams of the present application depict a particular set of steps in a specific order, other implementations may use fewer or more steps in the same or different order than those shown in the figures.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques under program instructions in firmware, memory, other storage, or a combination. Such special-purpose computing devices may combine custom hard-wired logic, Application-Specific Integrated Circuits (ASICs), or Field-Programmable Gate Arrays (FPGAs) with custom programming to accomplish these techniques. Special-purpose computing devices may include desktop computer systems, portable computer systems, handheld devices, networking devices, or any other device that incorporates both hard-wired and programmable logic to implement the techniques.

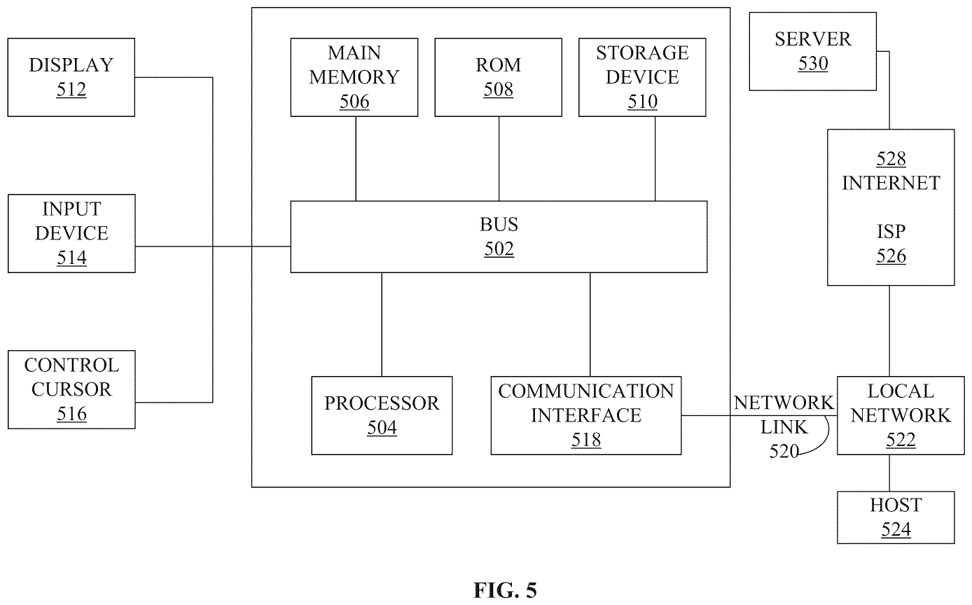

FIG. 5 is a block diagram that depicts an example computer system 500 upon which embodiments may be implemented. Computer system 500 includes a bus 502 or other communication mechanism for communicating information and a processor 504 coupled with bus 502 for processing information.

The bus 502 serves as the communication backbone of the system, interconnecting various components, including the processor 504, main memory 506, ROM 508, storage device 510, communication interface 518, display 512, input device 514, and control cursor 516. The bus 502 facilitates the transfer of data, instructions, and control signals between these components, promoting seamless operation and coordination, The bus 502 can be implemented using various technologies, such as a parallel bus architecture, a serial bus architecture, or a combination of these, depending on the system's performance requirements.

The design may also support multiple data transfer protocols, including USB or proprietary protocols, to address diverse data transfer needs. Bus 502 is designed to handle high-speed data transfers, resulting in minimal latency and efficient communication between its interconnected components.

The processor 504 is connected to the bus 502 and functions as the central processing unit (CPU) of the system. The processor 504 executes instructions stored in the main memory 506 or ROM 508 to perform various computational tasks. Depending on the system's performance requirements, the processor 504 may be designed as a single processing unit or as a unit with multiple processing capabilities. The processor 504 can be implemented using various architectures, such as x86, ARM, or RISC-V, to support different application scenarios. The processor 504 interacts with the main memory 506 to fetch and execute instructions and with the storage device 510 to retrieve or store data. Additionally, the processor 504 communicates with the communication interface 518 to manage data exchange with external networks and devices.

The processor 504 may also include specialized hardware accelerators, such as GPUs or AI accelerators, to enhance performance for specific tasks, including image processing and machine learning.

The main memory 506, connected to the bus 502, provides volatile storage for data and instructions that the processor 504 actively uses during operation. This component is typically implemented using dynamic random-access memory (DRAM) or static random-access memory (SRAM) technologies. The main memory 506 supports high-speed read and write operations, allowing the processor 504 to access data and instructions with minimal delay. The main memory 506 works in conjunction with the processor 504 to store intermediate computational results and with the storage device 510 to temporarily hold data retrieved from or written to non-volatile storage. The size and speed of the main memory 506 play a significant role in influencing the overall performance of the system.

The ROM 508, also connected to the bus 502, provides non-volatile storage for firmware and other instructions that the system relies on during startup or for basic functionality. The ROM 508 may be implemented using technologies such as EEPROM, flash memory, or mask ROM. The ROM 508 contains software components, such as the system's bootloader or basic input/output system (BIOS), which are executed by the processor 504 during the initialization phase. The ROM 508 ensures that the system can reliably boot and operate even in the absence of external storage devices. The ROM 508 works with the processor 504 to provide read-only access to the stored instructions and data.

The storage device 510, connected to the bus 502, provides non-volatile storage for the system's operating system, applications, and user data. The storage device 510 can be implemented using various technologies, such as hard disk drives (HDDs), solid-state drives (SSDs), or hybrid storage solutions. The storage device 510 interacts with the processor 504 to store and retrieve data as needed and with the main memory 506 to facilitate data transfer during computational tasks. The storage device 510 may also support advanced features, such as encryption or compression, to enhance data security and storage efficiency. The storage device 510 plays a crucial role in ensuring the system's long-term data retention and accessibility.

The display 512, connected to the bus 502, provides a visual interface for the user to interact with the system. The display 512 can be implemented using various display technologies, such as liquid crystal displays (LCDs), organic light-emitting diode (OLED) displays, or e-ink displays, depending on the application requirements. Graphical data is received by the display 512 from the processor 504 or a dedicated graphics processing unit (GPU) and is rendered for the user. The display 512 may also support touch input, enabling direct interaction with the system. Additionally, the display 512 works in conjunction with the input device 514 and control cursor 516 to enhance the user experience.

The input device 514, connected to the bus 502, allows the user to provide input to the system. This component can include various peripherals, such as keyboards, mice, touchpads, or styluses, depending on the system's design. The input device 514 interacts with the processor 504 to transmit user commands and communicates with the display 512 to enable interactive functionality. The input device 514 may also incorporate additional features, such as haptic feedback or gesture recognition, to enhance the user experience.

The control cursor 516, connected to the bus 502, facilitates precise management of the system's graphical user interface (GUI). This component may be realized as a hardware element, such as a trackball or joystick, or as a software element that processes input from the input device 514. The control cursor 516 interacts with the display 512 to provide visual feedback to the user and with the processor 504 to execute commands based on user input. The control cursor 516 significantly contributes to enabling intuitive and efficient navigation of the system's interface.

The communication interface 518, connected to the bus 502, facilitates data exchange between the system and external networks or devices. This component can be implemented using various technologies, such as Ethernet, Wi-Fi, Bluetooth, or cellular modems, depending on the system's connectivity requirements. The communication interface 518 interacts with the processor 504 to manage data transmission and reception and with the network link 520 to establish connections with external networks. The communication interface 518 may also include advanced features, such as network security protocols or data compression, to enhance communication efficiency and security.

The network link 520 connects the communication interface 518 to external networks, such as the local network 522 or the internet 528. The network link 520 can be implemented using either wired technologies, such as Ethernet cables, or wireless technologies, including Wi-Fi or cellular networks. The network link 520 interacts with the communication interface 518 to transmit and receive data and with the local network 522 or the internet 528 to establish connections with remote devices or servers. The network link 520 is significant in facilitating the system's networked functionality.

The local network 522, connected to the network link 520, provides a private communication environment for the system and other devices within the same network. The local network 522 can be implemented using various networking technologies, such as LANs or WLANs, depending on the system's requirements. This network interacts with the network link 520 to facilitate data exchange with external networks and communicates with the host 524 to enable interaction with other devices within the network.

The host 524, connected to the local network 522, represents a device or system that communicates with the system via the local network. The host 524 can be implemented as a computer, server, or IoT device, depending on the application scenario. This device or system interacts with the local network 522 to exchange data with the system and communicates with the processor 504 to execute commands or retrieve information.

The ISP 526, connected to the internet 528, provides internet connectivity to the system. The ISP 526 functions as an intermediary between the local network 522 and the internet 528, facilitating data exchange between these components. The ISP 526 interacts with the network link 520 to establish connections with the system and communicates with the internet 528 to enable access to remote servers or services.

The internet 528, connected to the ISP 526, provides a global communication network for the system. This network allows the system to access remote servers, services, or devices, supporting data exchange and functionality. The internet 528 works with the ISP 526 to establish connections with the system and collaborates with the server 530 to enable communication with remote resources.

Server 530, connected to the internet via 528, provides remote services or resources to the system. The server 530 can be implemented as a physical server, a virtual server, or a cloud-based service, depending on the application requirements. The server 530 interacts with the internet 528 to exchange data with the system and communicates with the processor 504 to execute commands or retrieve information. The server 530 is significant in supporting the system's remote functionality and scalability.

In the foregoing specification, embodiments have been described with reference to numerous specific details that may vary from implementation to implementation. Thus, the sole and exclusive indicator of what is, and what the applicants intend to be, is the approach, which is the set of claims issued from this application in the specific form in which such claims are issued, including any subsequent corrections. Hence, no limitation, element, property, feature, advantage, or attribute that is not expressly recited in a claim should limit the scope of such claim in any way. Accordingly, the specification and drawings should be regarded as illustrative rather than restrictive.

What is claimed is:

1. A computer-implemented method for generating and refining synthetic video content of customizable products, the method comprising:
receiving a text prompt describing a product and a markup;
based, at least in part, on the text prompt, generating a synthetic image of the product having the markup using a generative artificial intelligence system;
validating the synthetic image against physical product specifications to ensure conformity;
mapping the synthetic image onto a 3D surface;
applying inpainting techniques to remove the markup while preserving underlying fabric details;
generating an enhanced synthetic image by incorporating lighting and specular effects into the synthetic image to enhance realism of the synthetic image;
using quadrilateral grid interpolation, generating an interactive asset by mapping the enhanced synthetic image onto the 3D surface of the product;
based on the enhanced synthetic image and the interactive asset, generating using the generative artificial intelligence system a video frame sequence, where each video frame of the video frame sequence depicts the interactive asset having the enhanced synthetic image;
for each frame of the video frame sequence, generating a vector data file for the interactive asset;
generating a video data file based on each vector data file generated for each frame of the video frame sequence, and customization instructions for customizing appearance of the interactive asset; and
transmitting the video data file and the customization instructions to a manufacturing entity to cause the manufacturing entity to render the interactive asset.

2. The method of claim 1, further comprising:
generating a new video frame sequence by applying one or more filters to the video frame sequence to capture a geometry of the interactive asset depicted in the video frame sequence;
based on the new video frame sequence, generating a new vector data file for each frame in the video frame sequence and new customization instructions for customizing appearance of the interactive asset;
wherein the new vector data file includes information about vertices and the geometry of the interactive asset depicted in the frame;
storing the new vector data file and the new customization instructions in a database at a particular location;
transmitting, to a client computer, the new vector data file, an address to the particular location, and the new customization instructions to cause the client computer to execute the new customization instructions with respect to the new vector data file to re-render the interactive asset.

3. The method of claim 1, wherein the interactive asset is displayed as an overlay;
wherein a display of the interactive asset in one frame of the video frame sequence is overlaid by a display of the interactive asset in a successive frame of the video frame sequence;
wherein the interactive asset enables real-time customization of the enhanced synthetic image;
wherein displaying the interactive asset enables real-time customization of the synthetic image.

4. The method of claim 1, further comprising:
applying inpainting techniques to the interactive asset to remove the markup while preserving underlying product details;
wherein the inpainting techniques use texture synthesis algorithms to preserve additional product details.

5. The method of claim 1, wherein the text prompt includes specific product attributes such as color, size, or material;
wherein a quadrilateral grid used in the quadrilateral grid interpolation is constructed from a first synthetic output of the generative artificial intelligence system, and is modified and used as an image input to correct a subsequent generation of the synthetic image;
wherein the generative artificial intelligence system utilizes different AI models for generating synthetic images.

6. The method of claim 1, further comprising:
simulating various lighting scenarios, such as natural or artificial light, to enhance realism of the enhanced synthetic image;
validating the enhanced synthetic image against physical product specifications of the product to ensure conformity;
comparing the enhanced synthetic image with a database of physical product specifications for validation.

7. An apparatus for generating and refining synthetic images of customizable products, comprising:
a generative artificial intelligence system configured to:
receiving a text prompt describing a product and a markup;
create synthetic images with digital markups based on user inputs;
a validation and correction module configured to validate and correct the synthetic images to ensure conformity with physical product specifications;
a 3D mapping and image synthesis module configured to map user images onto 3D surfaces;
an inpainting module configured to remove digital markups from the synthetic images while preserving underlying fabric details;
an interactive asset creation system configured to:
generating an enhanced synthetic image by incorporating lighting and specular effects into the synthetic image to enhance realism of the synthetic image;
using quadrilateral grid interpolation, generating an interactive asset by mapping the enhanced synthetic image onto the 3D surface of the product;
based on the enhanced synthetic image and the interactive asset, generating using the generative artificial intelligence system a video frame sequence, where each video frame of the video frame sequence depicts the interactive asset having the enhanced synthetic image;
for each frame of the video frame sequence, generating a vector data file for the interactive asset;
generating a video data file based on each vector data file generated for each frame of the video frame sequence, and customization instructions for customizing appearance of the interactive asset; and
transmitting the video data file and the customization instructions to a manufacturing entity to cause the manufacturing entity to render the interactive asset.

8. The apparatus of claim 7, wherein the generative artificial intelligence system is further configured to:
generating a new video frame sequence by applying one or more filters to the video frame sequence to capture a geometry of the interactive asset depicted in the video frame sequence;
based on the new video frame sequence, generating a new vector data file for each frame in the video frame sequence and new customization instructions for customizing appearance of the interactive asset;
wherein the new vector data file includes information about vertices and the geometry of the interactive asset depicted in the frame;
storing the new vector data file and the new customization instructions in a database at a particular location;
transmitting, to a client computer, the new vector data file, an address to the particular location, and the new customization instructions to cause the client computer to execute the new customization instructions with respect to the new vector data file to re-render the interactive asset.

9. The apparatus of claim 7, wherein the interactive asset is displayed as an overlay;
wherein a display of the interactive asset in one frame of the video frame sequence is overlaid by a display of the interactive asset in a successive frame of the video frame sequence;
wherein the interactive asset enables real-time customization of the enhanced synthetic image;
wherein displaying the interactive asset enables real-time customization of the synthetic image.

10. The apparatus of claim 7, wherein the generative artificial intelligence system is further configured to:
applying inpainting techniques to the interactive asset to remove the markup while preserving underlying product details;
wherein the inpainting techniques use texture synthesis algorithms to preserve additional product details.

11. The apparatus of claim 7, wherein the text prompt includes specific product attributes such as color, size, or material;
wherein a quadrilateral grid used in the quadrilateral grid interpolation is constructed from a first synthetic output of the generative artificial intelligence system, and is modified and used as an image input to correct a subsequent generation of the synthetic image;
wherein the generative artificial intelligence system utilizes different AI models for generating synthetic images.

12. The apparatus of claim 7, wherein the generative artificial intelligence system is further configured to:
simulating various lighting scenarios, such as natural or artificial light, to enhance realism of the enhanced synthetic image;
validating the enhanced synthetic image against physical product specifications of the product to ensure conformity;
comparing the enhanced synthetic image with a database of physical product specifications for validation.

13. A non-transitory, computer-readable storage medium storing one or more computer instructions which, when executed by one or more computer processors, cause the one or more computer processors to perform:
receiving a text prompt describing a product and a markup;
based, at least in part, on the text prompt, generating a synthetic image of the product having the markup using a generative artificial intelligence system;
validating the synthetic image against physical product specifications to ensure conformity;
mapping the synthetic image onto a 3D surface;
applying inpainting techniques to remove the markup while preserving underlying fabric details;
generating an enhanced synthetic image by incorporating lighting and specular effects into the synthetic image to enhance realism of the synthetic image;
using quadrilateral grid interpolation, generating an interactive asset by mapping the enhanced synthetic image onto the 3D surface of the product;
based on the enhanced synthetic image and the interactive asset, generating using the generative artificial intelligence system a video frame sequence, where each video frame of the video frame sequence depicts the interactive asset having the enhanced synthetic image;
for each frame of the video frame sequence, generating a vector data file for the interactive asset;
generating a video data file based on each vector data file generated for each frame of the video frame sequence, and customization instructions for customizing appearance of the interactive asset; and
transmitting the video data file and the customization instructions to a manufacturing entity to cause the manufacturing entity to render the interactive asset.

14. The non-transitory, computer-readable storage medium according to claim 13, storing additional instructions for:
generating a new video frame sequence by applying one or more filters to the video frame sequence to capture a geometry of the interactive asset depicted in the video frame sequence;
based on the new video frame sequence, generating a new vector data file for each frame in the video frame sequence and new customization instructions for customizing appearance of the interactive asset;
wherein the new vector data file includes information about vertices and the geometry of the interactive asset depicted in the frame;
storing the new vector data file and the new customization instructions in a database at a particular location;
transmitting, to a client computer, the new vector data file, an address to the particular location, and the new customization instructions to cause the client computer to execute the new customization instructions with respect to the new vector data file to re-render the interactive asset.

15. The non-transitory, computer-readable storage medium according to claim 13, wherein the interactive asset is displayed as an overlay;
wherein a display of the interactive asset in one frame of the video frame sequence is overlaid by a display of the interactive asset in a successive frame of the video frame sequence;
wherein the interactive asset enables real-time customization of the enhanced synthetic image;
wherein displaying the interactive asset enables real-time customization of the synthetic image.

16. The non-transitory, computer-readable storage medium according to claim 13, storing additional instructions for:
applying inpainting techniques to the interactive asset to remove the markup while preserving underlying product details;
wherein the inpainting techniques use texture synthesis algorithms to preserve additional product details.

17. The non-transitory, computer-readable storage medium according to claim 13, wherein the text prompt includes specific product attributes such as color, size, or material;
wherein a quadrilateral grid used in the quadrilateral grid interpolation is constructed from a first synthetic output of the generative artificial intelligence system, and is modified and used as an image input to correct a subsequent generation of the synthetic image;
wherein the generative artificial intelligence system utilizes different AI models for generating synthetic images.

18. The non-transitory, computer-readable storage medium according to claim 13, storing additional instructions for:
simulating various lighting scenarios, such as natural or artificial light, to enhance realism of the enhanced synthetic image;
validating the enhanced synthetic image against physical product specifications of the product to ensure conformity;
comparing the enhanced synthetic image with a database of physical product specifications for validation.
